(19) United States
(12) Patent Application Publication
(10) Pub. No.: US 2019/0203521 A1
(43) Pub. Date: Jul. 4, 2019

(54) ASTRAGAL ASSEMBLY

(71) Applicant: Trinity Glass International, Inc., Federal Way, WA (US)

(72) Inventor: Victor Massey, Orting, WA (US)

(21) Appl. No.: 16/227,748

(22) Filed: Dec. 20, 2018

Related U.S. Application Data
(60) Provisional application No. 62/612,187, filed on Dec. 29, 2017.

(51) Int. Cl. E06B 3/36; E05C 7/04; E05C 9/04; E05C 9/14

(52) U.S. Cl. CPC E06B 3/365; E05C 9/14; E05C 9/04; E05C 7/045

(57) ABSTRACT

An astragal assembly mounted on a passive panel hingedly coupled to a frame. The astragal assembly includes a slide bolt assembly with a distally extending projection. The slide bolt assembly is movable between distal and proximal positions with respect to the passive panel. The projection is receivable inside an opening along the frame when the slide bolt assembly is in the distal position to thereby prevent the passive panel from being rotated to an open position from a closed position. The projection is spaced apart from the opening when the slide bolt assembly is in the proximal position to thereby allow the passive panel to be rotated to the open position from the closed position.

### BACKGROUND OF THE INVENTION

### Field of the Invention

The present invention is directed generally to astragal assemblies for use between a pair of doors or panels.

### Description of the Related Art

An astragal assembly is a mechanism positioned between double doors (e.g., French doors) or panels. Double doors include an active door and a passive door installed in the same doorframe. The astragal assembly is used to selectively prevent the passive door from opening. Unfortunately, currently available astragal assemblies have many shortcomings.

For example, currently available astragal assemblies are typically difficult to seal and allow water to leak through. Sealing systems can be installed but often interfere when the doors are opened or closed. Manufacturing and/or installing custom sized doors (e.g., having custom heights), which are common in many buildings, may compromise these seals. Additionally, double doors and astragal assemblies can be difficult to install.

Many currently available astragal assemblies include a pair of movable shoot bolts configured to be selectively inserted into openings in the doorframe. Unfortunately, such shoot bolts may be difficult to reach and/or operate. It can also be difficult to determine if astragal assemblies are completely secure. For example, it can be difficult to determine if the shoot bolts are fully received inside the openings in the doorframe. Further, even if the shoot bolts are fully received, astragal assemblies are somewhat insecure and require the installation of separate locking mechanisms configured to prevent intruders from gaining unwanted entry. Unfortunately, strike plates and latches of such locking mechanisms often interfere with the shoot bolts and other operating mechanisms.

### BRIEF DESCRIPTION OF THE SEVERAL VIEWS OF THE DRAWING(S)

FIG. 1A is a rear view of an astragal assembly positioned between an active door and a passive door both installed in a doorframe.

FIG. 1B is a rear perspective view of the astragal assembly attached to the passive door with the both active and passive doors in open positions.

FIG. 2 is a rear perspective view of an embodiment of the astragal assembly that includes a multipoint lock configuration.

FIG. 3 is a partially exploded front perspective view of the astragal assembly of FIG. 1A.

FIG. 4 is a perspective view of a first side of an upper portion of an astragal body of the astragal assembly of FIG. 1A.

FIG. 5 is a perspective view of a second side of the upper portion of the astragal body of the astragal assembly of FIG. 1A.

FIG. 6 is an exploded perspective view of a lever assembly of the astragal assembly of FIG. 1A.

FIG. 7 is a perspective view of a first side of a lever of the lever assembly of FIG. 6.

FIG. 8 is a perspective view of a second side of the lever of the lever assembly of FIG. 6.

FIG. 9 is a perspective view of the lever assembly of FIG. 6 illustrated with the lever in a locked position.

FIG. 10 is a perspective view of the lever assembly of FIG. 6 illustrated with the lever in an unlocked position.

FIG. 11 is a partially exploded front perspective view of the astragal body, the lever assembly, and upper and lower connecting rods of the astragal assembly of FIG. 1A.

FIG. 12 is an exploded perspective view of an upper slide bolt assembly of the astragal assembly of FIG. 1A.

FIG. 13A is a perspective view of the upper portion of the astragal body and the upper slide bolt assembly.

FIG. 13B is a perspective view of a lower portion of the astragal body and a lower slide bolt assembly.

FIG. 14 is a perspective view of a distal portion of a shoot bolt member of each of the upper and lower slide bolt assemblies.

FIG. 15 is a perspective view of the shoot bolt member of each of the upper and lower slide bolt assemblies.

FIG. 16 is an exploded rear perspective view of a sill receiver assembly and a cross-sectional view of a sill member of the doorframe of FIG. 1A.

FIG. 17 is an exploded bottom perspective view of a sill receiver member and a receiver gasket of the sill receiver assembly of FIG. 16.

FIG. 18A is a cross-sectional view of the upper portion of the astragal assembly in the locked configuration.

FIG. 18B is a cross-sectional view of the upper portion of the astragal assembly in the unlocked configuration.

FIG. 19A is a cross-sectional view of the lower portion of the astragal assembly in the locked configuration.

FIG. 19B is a cross-sectional view of the lower portion of the astragal assembly in the unlocked configuration.

FIG. 20 is a perspective view of an embodiment of the astragal assembly that includes a reinforcement member.

FIG. 21 is a cross-sectional view of the embodiment of the astragal assembly of FIG. 20 taken near the upper portion of the astragal body.

Like reference numerals have been used in the figures to identify like components.

### DETAILED DESCRIPTION OF THE INVENTION

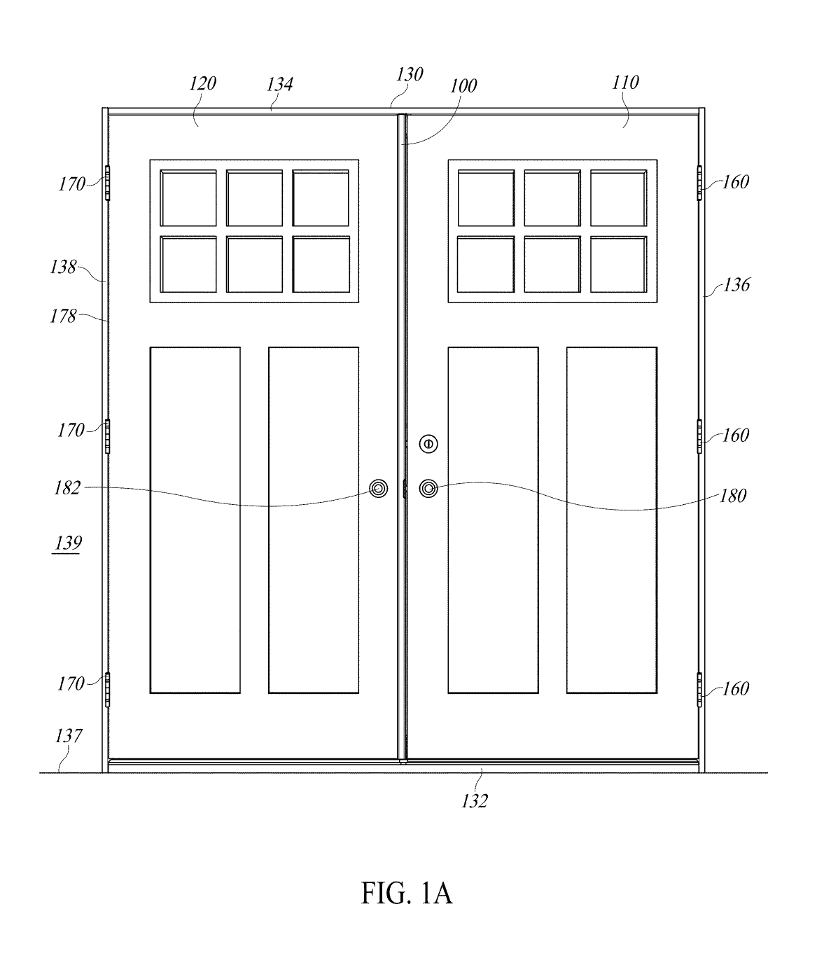

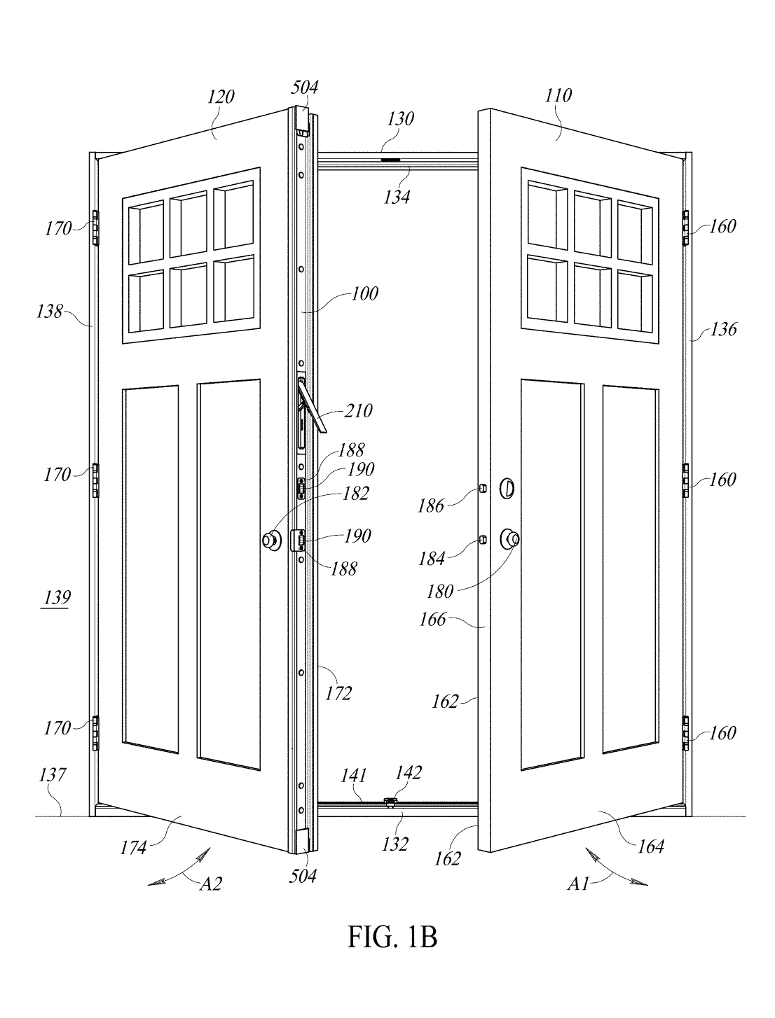

FIGS. 1A and 1B illustrate an astragal assembly 100 positioned between an active door 110 and a passive door 120. The active and passive doors 110 and 120 are mounted in a doorframe 130 that includes a sill member 132, a header member 134, a first jamb member 136, and a second jamb member 138. Optionally, weather stripping (not shown) may be positioned between the passive door 120 and the first jamb member 136, and weather stripping (not shown) may be positioned between the active door 110 and the second jamb member 138.

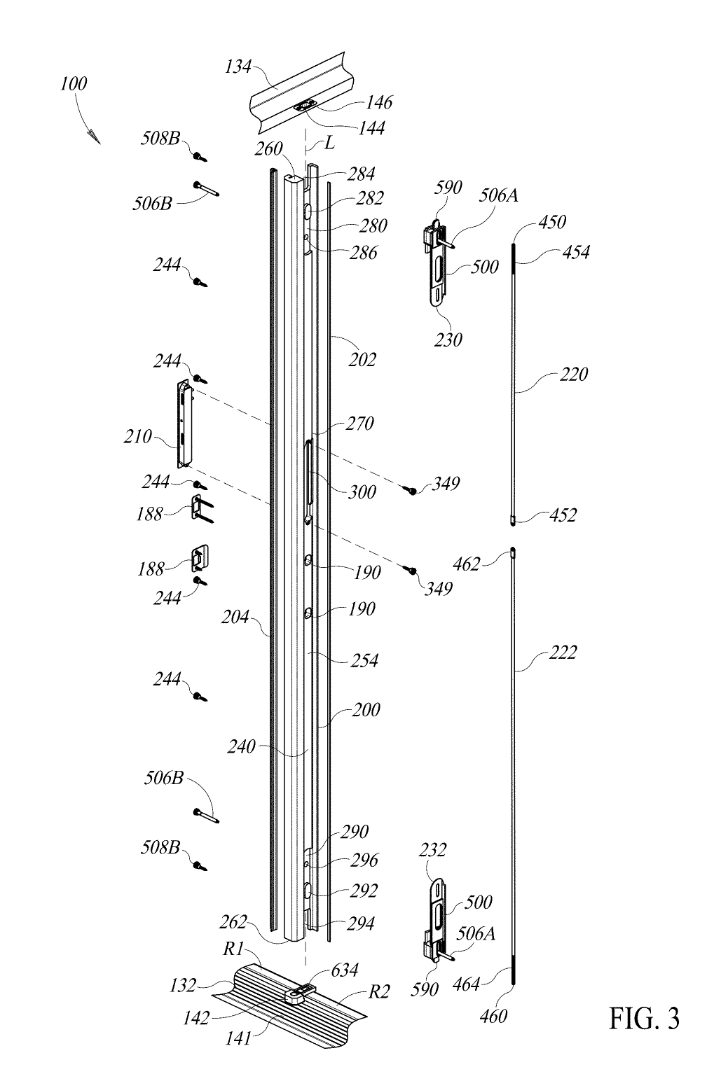

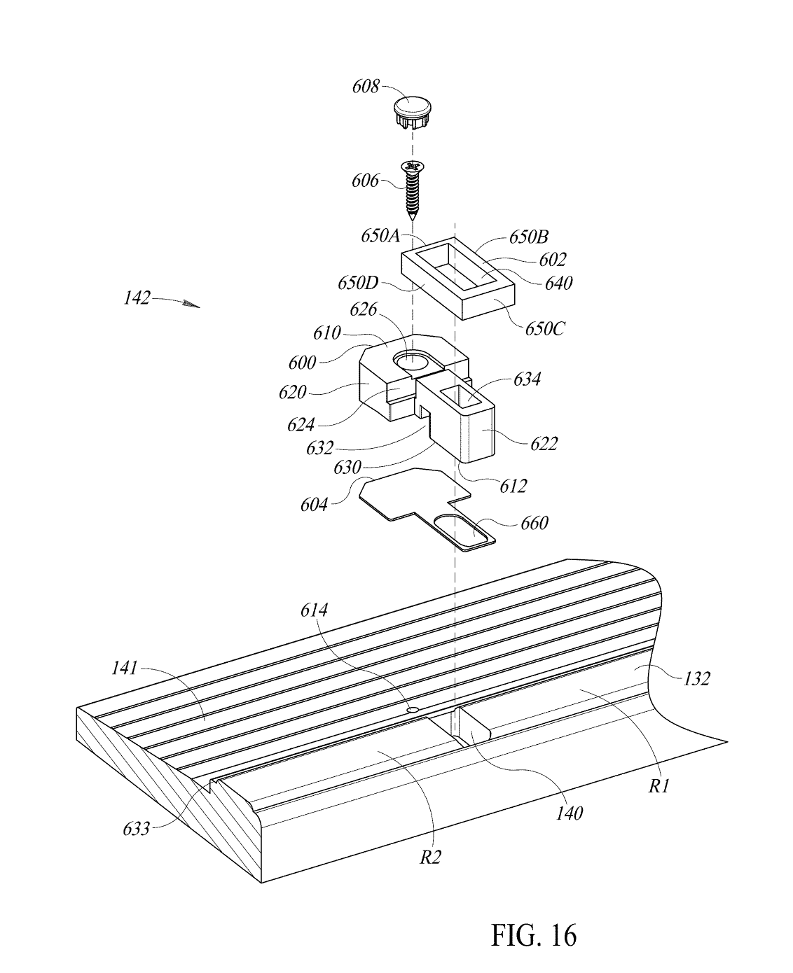

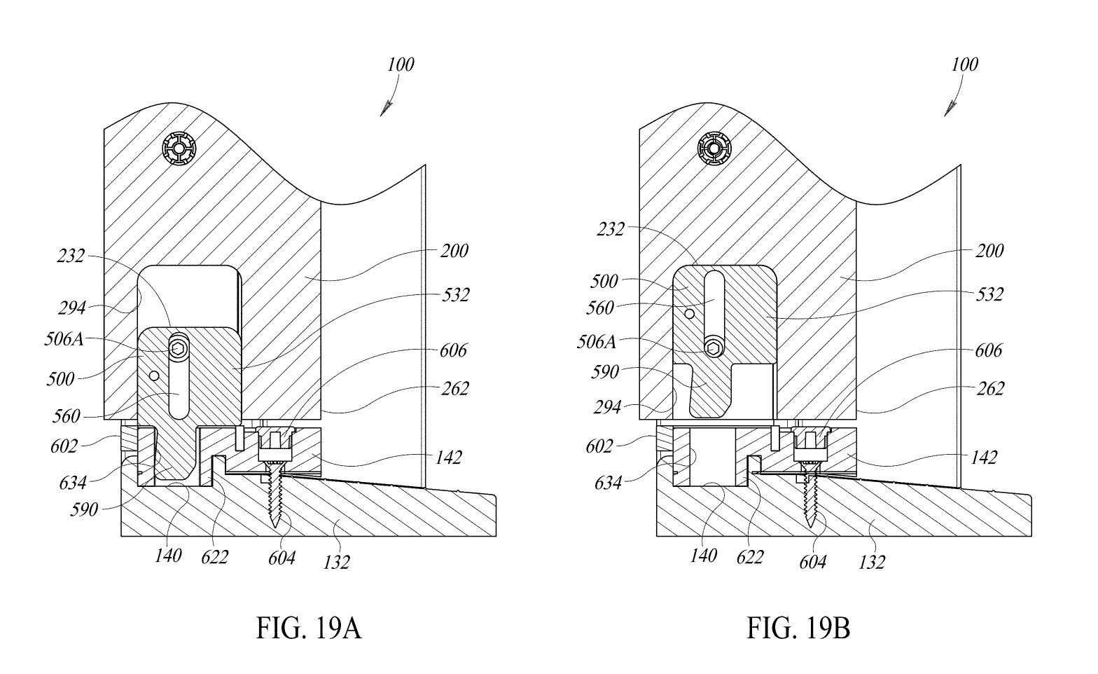

Referring to FIG. 1B, the sill member 132 extends along the ground or a floor 137 in a structure 139 (e.g., a house). The sill member 132 has an opening or recess 140 (see FIGS. 16, 19A, and 19B) extending downwardly from its upper surface 141. Referring to FIG. 3, in the embodiment illustrated, the recess 140 (see FIGS. 16, 19A, and 19B) may be formed between a pair of adjustable rails “R1” and “R2.” A sill receiver assembly 142 may be mounted in the recess 140 (see FIGS. 16, 19A, and 19B) between the pair of adjustable rails “R1” and “R2.” The header member 134 has a recess or slot 144 formed therein. An optional strike plate 146 may be mounted on the header member 134 and at least partially surround the slot 144.

Referring to FIG. 1B, the active door 110 is hingedly attached to the first jamb member 136 by one or more first hinges 160. The active door 110 is rotatable (in directions indicated by double headed arrow A1“)” on the first hinge(s) 160 relative to the first jamb member 136 between a closed position (see FIG. 1A) and an open position (see FIG. 1B). The active door 110 has a forward facing side 162 opposite a rearward facing side 164. The active door 110 has a free edge 166 opposite the first jamb member 136.

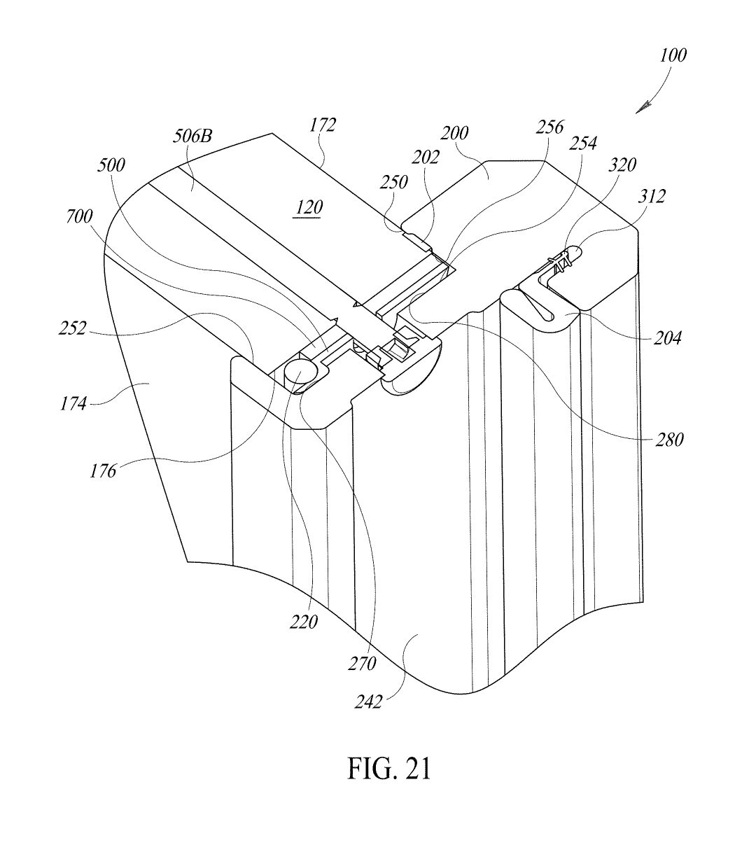

Similarly, the passive door 120 is hingedly attached to the second jamb member 138 by one or more second hinges 170. The passive door 120 is rotatable (in directions indicated by double headed arrow “A2”) on the second hinge(s) 170 relative to the second jamb member 138 between a closed position (see FIG. 1A) and an open position (see FIG. 1B). The passive door 120 has a forward facing side 172 (see FIG. 21) opposite a rearward facing side 174. The passive door 120 has a free edge 176 (see FIG. 21) opposite an edge 178 (see FIG. 1B) that is hingedly connected to the second jamb member 138 by the second hinge(s) 170. Referring to FIG. 1B, the astragal assembly 100 is attached to the free edge 176 (see FIG. 21) of the passive door 120. The astragal assembly 100 rotates with the passive door 120 as a unit when the passive door 120 is rotated on the second hinge(s) 170.

By way of a non-limiting example, the forward facing sides 162 and 172 of the active and passive doors 110 and 120, respectively, may face outwardly from the structure 139 and the rearward facing sides 164 and 174 of the active and passive doors 110 and 120, respectively, may face inwardly into the structure 139. However, as is apparent to those of ordinary skill in the art, the active and passive doors 110 and 120 may be positioned between adjacent rooms in the structure 139. For ease of illustration, the active and passive doors 110 and 120 have been illustrated as being rotatable rearwardly. Thus, the active and passive doors 110 and 120 may be described as being inswing doors. However, in alternate embodiments, the active and passive doors 110 and 120 may be rotatable forwardly (as outswing doors) or rotatable both rearwardly and forwardly.

The active and passive doors 110 and 120 may include doorknobs 180 and 182, respectively, positioned near the astragal assembly 100 when the active and passive doors 110 and 120 are both in the closed position (see FIG. 1A). The doorknob 180 may operate a lock mechanism 184 configured to lock the active and passive doors 110 and 120 together in closed positions (see FIG. 1A). Optionally, the active door 110 may include one or more additional lock mechanisms 186 (e.g., a deadbolt lock). The passive door 120 includes a different strike plate 188 and opening 190 configured to mate with each of the lock mechanisms 184 and 186.

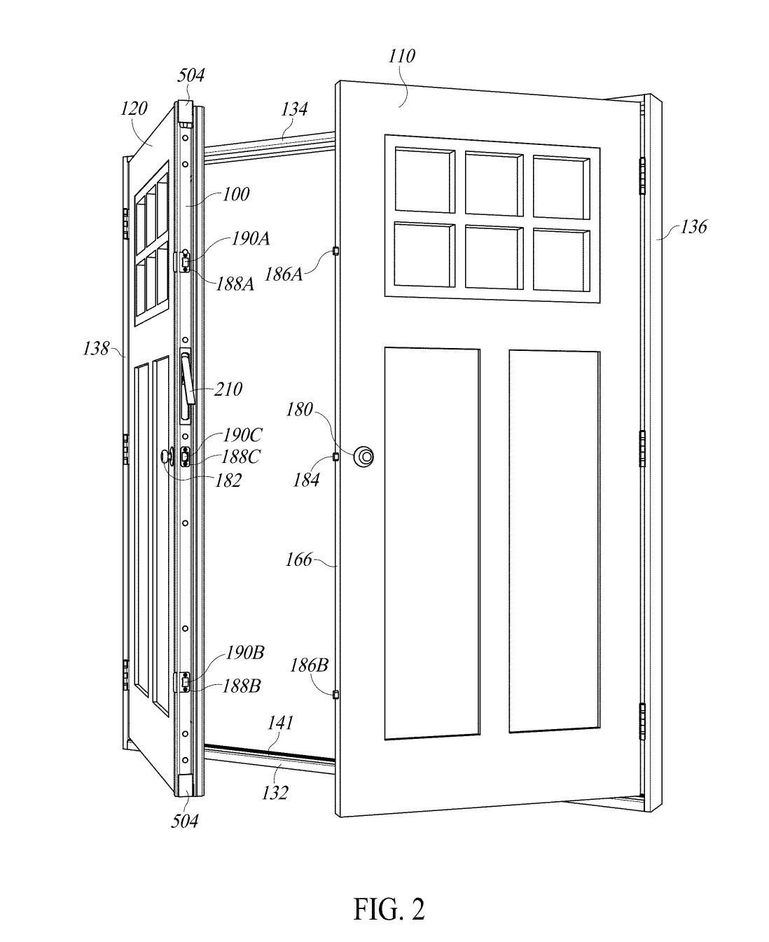

FIG. 2 illustrates an embodiment of the astragal assembly 100 in which the lock mechanism(s) 186 (see FIG. 1B) include two additional lock mechanisms 186A and 186B configured to mate with openings 190A and 190B, respectively, formed in the astragal assembly 100. The openings 190A and 190B are surrounded by strike plates 188A and 188B, respectively. In FIG. 2, the astragal assembly 100 also include an opening 190C (surrounded by a strike plate 188C) configured to mate with the lock mechanism 184. In FIG. 2, the lock mechanisms 184, 186A, and 186B may be locked and unlocked by operating the doorknob 180. Thus, FIG. 2 may be characterized as illustrating a multipoint lock configuration.

Referring to FIG. 1B, the astragal assembly 100 is configured to transition between an unlocked configuration (see FIGS. 1B, 18B, and 19B) and a locked configuration (see FIGS. 1A, 18A, and 19A). The astragal assembly 100 prevents the passive door 120 from rotating on the second hinge(s) 170 when the astragal assembly 100 is in the locked configuration (see FIGS. 1A, 18A, and 19A) and the passive door 120 is in the closed position (see FIG. 1A). Thus, when the astragal assembly 100 is in the locked configuration (see FIGS. 1A, 18A, and 19A) and the passive door 120 is in the closed position (see FIG. 1A), the lock mechanism 184 and/or the lock mechanism(s) 186 may lock the active door 110 to the non-rotatable passive door 120 to thereby also prevent the active door 110 from be rotated on the first hinge(s) 160.

As shown in FIG. 2, the astragal assembly 100 may be locked and unlocked independently from the lock mechanisms (e.g., the lock mechanisms 184, 186A, and 186B) of the multipoint lock configuration. Additionally, the lock mechanisms (e.g., the lock mechanisms 184, 186A, and 186B) of the multipoint lock configuration may be locked and unlocked independently of the astragal assembly 100. Thus, the astragal assembly 100 does not interfere with the lock mechanisms (e.g., the lock mechanisms 184, 186A, and 186B) of the multipoint lock configuration and vice versa.

The astragal assembly 100 may be installed within any frame (e.g., like the doorframe 130) optionally positioned with an opening formed in a wall. While the astragal assembly 100 has been illustrated as being installed between the active and passive doors 110 and 120, in alternate embodiments, the astragal assembly 100 may be installed in a single door, panel, window (e.g., a sliding window, a single hung window, a double hung window, and the like), or skylight. Further, the astragal assembly 100 may be installed between two panels, doors (e.g., French doors, double doors, sliding doors, and the like), windows (e.g., French windows, sliding windows, single hung windows, double hung windows, and the like), or skylights.

Referring to FIG. 3, the astragal assembly 100 includes an astragal body 200, glazing tape 202, weather stripping 204, a lever assembly 210, an upper connecting rod 220, a lower connecting rod 222, an upper slide bolt assembly 230, and a lower slide bolt assembly 232. The lever assembly 210 is operable to transition the astragal assembly 100 between the locked configuration (see FIGS. 1A, 18A, and 19A) and the unlocked configuration (see FIGS. 1B, 18B, and 19B) and vice versa.

### Astragal Body

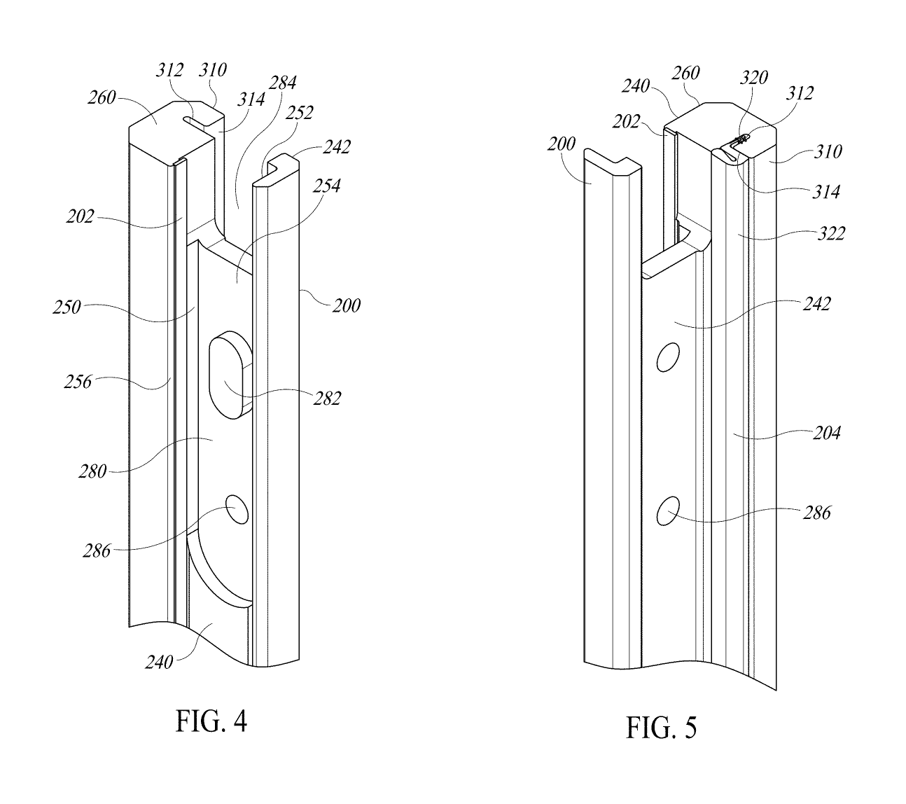

Referring to FIG. 3, the astragal body 200 extends along an upright longitudinal axis “L.” The astragal body 200 has a first side 240 opposite a second side 242 (see FIGS. 5 and 21). Referring to FIG. 4, the first side 240 has a generally U-shaped cross-sectional profile shape configured to receive and be attached to the free edge 176 (see FIG. 21) of the passive door 120 (see FIGS. 1A-2 and 21) by one or more fasteners 244 (see FIG. 3). Thus, the first side 240 has outwardly extending spaced apart first and second lateral walls 250 and 252 connected together by a connecting portion 254. The connecting portion 254 is configured to be positioned adjacent the free edge 176 (see FIG. 21) of the passive door 120 (see FIGS. 1A-2 and 21). Referring to FIG. 21, the first and second lateral walls 250 and 252 extend from the connecting portion 254 along the forward and rearward facing sides 172 and 174, respectively, of the passive door 120. The glazing tape 202 is attached to a door facing surface 256 of the first lateral wall 250 between the passive door 120 and the first lateral wall 250.

Referring to FIG. 3, the astragal body 200 has an upper end portion 260 opposite a lower end portion 262 along the longitudinal axis “L.” Referring to FIG. 4, at the upper end portion 260, the second lateral wall 250 may extend upwardly farther than the first lateral wall 250. However, referring to FIG. 3, at the lower end portion 262, the first and second lateral walls 250 and 252 (see FIG. 4) may extend downwardly the same distance.

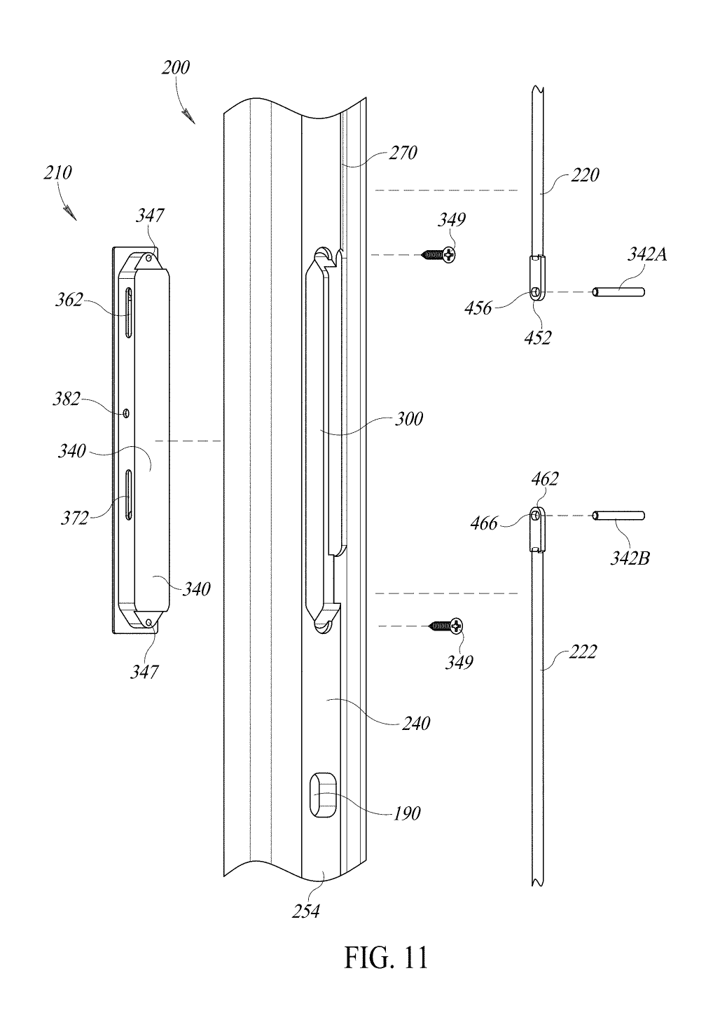

Referring to FIGS. 11 and 21, the connecting portion 254 includes a linear groove or channel 270 that extends along the longitudinal axis “L” (see FIG. 3) from the upper end portion 260 (see FIGS. 3-5, 13A, 18A, and 18B) to the lower end portion 262 (see FIGS. 3, 13B, 19A, and 19B). Referring to FIG. 3, the channel 270 is configured to receive the upper and lower connecting rods 220 and 222 and allow them to slide linearly therein along both the longitudinal axis “L” and the free edge 176 (see FIG. 21) of the passive door 120 (see FIGS. 1A-2 and 21).

Referring to FIG. 4, in the upper end portion 260, the connecting portion 254 includes an upper recess 280 formed alongside the channel 270 (see FIGS. 3, 11, and 21). A laterally extending upper guide projection 282 extends into the upper recess 280. Above the upper guide projection 282, a distal through-hole 284 is formed in the upper end portion 260. Below the upper guide projection 282, a proximal through-hole 286 is formed in the upper end portion 260.

Referring to FIG. 3, the lower end portion 262 is a mirror image of the upper end portion 260. Thus, in the lower end portion 262, the connecting portion 254 includes a lower recess 290 formed alongside the channel 270. A laterally extending lower guide projection 292 extends into the lower recess 290. Below the lower guide projection 292, a distal through-hole 294 is formed in the lower end portion 262. Above the lower guide projection 292, a proximal through-hole 296 is formed in the lower end portion 262.

The connecting portion 254 has an aperture 300 configured to house the lever assembly 210 positioned between the upper and lower recesses 280 and 290. The connecting portion 254 includes the openings 190 configured to mate with (e.g., bolts of) the lock mechanisms 184 and 186 (see FIGS. 1B and 2).

Referring to FIG. 5, the second side 242 of the astragal body 200 faces the free edge 166 (see FIGS. 1B and 2) of the active door 110 (see FIGS. 1A-2) and has a generally J-shaped cross-sectional profile shape. Thus, the second side 242 has an outwardly extending stop portion 310 with a slot 312 formed therein. The stop portion 310 includes a rearwardly facing surface 314.

By way of a non-limiting example, the astragal body 200 may be constructed from polyvinyl chloride (“PVC”).

### Glazing Tape

As mentioned above, referring to FIG. 4, the glazing tape 202 is attached to the door facing surface 256 of the first lateral wall 250. Referring to FIG. 3, the glazing tape 202 may extend between the upper and lower end portions 260 and 262. In some embodiments, the glazing tape 202 is cut flush with the distalmost edges of the upper and lower end portions 260 and 262. The glazing tape 202 may be installed at the same time as the weather stripping 204.

By way of a non-limiting example, the glazing tape 202 may be implemented using double-sided polyethylene (“PE”) foam coated on one side with a pressure sensitive adhesive. For example, the glazing tape 202 may be double coated with aggressive acrylic pressure sensitive adhesive on one side and double coated with acrylic on the other (door facing) side. A plastic release liner (not shown) may be adhered to the pressure sensitive adhesive before the glazing tape 202 is attached to the astragal body 200. Referring to FIG. 4, the liner (not shown) may be removed and the glazing tape 202 adhered to the door facing surface 256 by the pressure sensitive adhesive. By way of a non-limiting example, the glazing tape 202 may be about 1/16 inch thick and about ¼ inch wide. The glazing tape 202 may satisfy American Architectural Manufactures Association (“AAMA”), Specification 810.1, Type 1 for Cellular Glazing Tapes. An example of such a glazing tape includes 3M™ Venture Tape™ Double Sided PE Foam Glazing Tape

### Weather Stripping

Referring to FIG. 5, the weather stripping 204 has an anchor portion 320 that extends outwardly from a body portion 322. The slot 312 formed in the stop portion 310 of the astragal body 200 is configured to receive the anchor portion 320 and position the body portion 322 to abut the forwardly facing surface 314 of the stop portion 310. Thus, the weather stripping 204 is attached to the second side 242 of the astragal body 200 between the active door 110 (see FIGS. 1A-2) and the astragal body 200. Referring to FIG. 3, the weather stripping 204 may extend between the upper and lower end portions 260 and 262. In some embodiments, the weather stripping 204 is cut flush with the distalmost edges of the stop portion 310 (see FIGS. 4 and 5) at the upper and lower end portions 260 and 262.

By way of a non-limiting example, the weather stripping 204 may be constructed from an open-celled urethane foam core clad in an embossed polyethylene liner. An example of such a door seal is Q-LON® QEBD 650 Door Seal sold by Schlegel (an Amesbury Company) of Rochester, N.Y.

### Lever Assembly

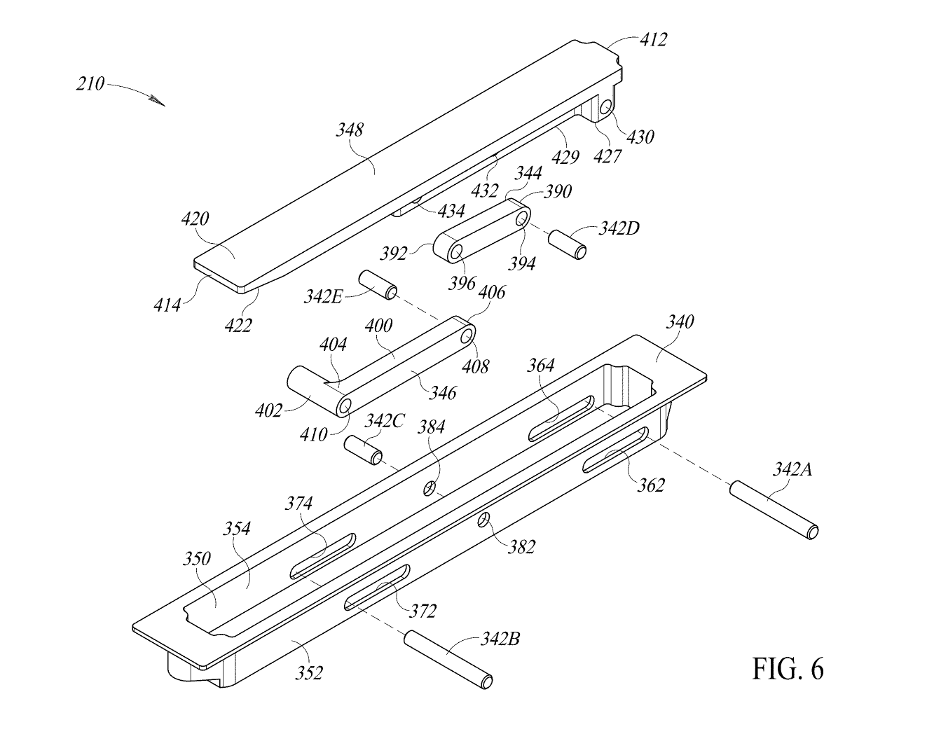

Referring to FIG. 6, the lever assembly 210 includes a chassis 340, five pivot pins 342A-342E, a first link member 344, a second link member 346, and a lever 348. Referring to FIG. 11, the first pivot pin 342A is connected to the upper connecting rod 220 and the second pivot pin 342B is connected to the lower connecting rod 222.

The chassis 340 is configured to be mounted in the aperture 300 of the astragal body 200. In the embodiment illustrated, the chassis 340 has one or more openings 347 each configured to receive a fastener 349 that fastens the chassis 340 to the astragal body 200 within the aperture 300. Referring to FIG. 6, the chassis 340 has a hollow interior 350 partially defined by a first longitudinally extending sidewall 352 opposite a substantially parallel second longitudinally extending sidewall 354. The first and second sidewalls 352 and 354 are spaced apart from one another laterally across the hollow interior 350.

The first and second sidewalls 352 and 354 have first and second upper through-slots 362 and 364, respectively, juxtaposed with one another across the hollow interior 350. The first pivot pin 342A is configured to be received inside the first and second upper through-slots 362 and 364 and to both pivot and slide therein. The first and second sidewalls 352 and 354 include first and second lower through-slots 372 and 374, respectively, juxtaposed with one another across the hollow interior 350. The second pivot pin 342B is configured to be received inside the first and second lower through-slots 372 and 374 and to both pivot and slide therein.

At least one of the first and second sidewalls 352 and 354 has an intermediate through-hole positioned longitudinally between the upper through-slots 362 and 364 and the lower through-slots 372 and 374. In the embodiment illustrated, the first and second sidewalls 352 and 354 include first and second intermediate through-holes 382 and 384, respectively, juxtaposed with one another across the hollow interior 350. The third pivot pin 342C is configured to be received inside at least one of the intermediate through-holes 382 and 384 and to pivot therein. In the embodiment illustrated, the third pivot pin 342C is received inside the second intermediate through-hole 384. However, in alternate embodiments, the third pivot pin 342C may be received inside the first intermediate through-hole 382.

The first link member 344 has a generally linear shape with a first end portion 390 opposite a second end portion 392. A laterally extending first through-hole 394 is formed in the first end portion 390 and a laterally extending second through-hole 396 is formed in the second end portion 392. The first through-hole 394 is configured to receive the fourth pivot pin 342D and to pivot thereabout. The second through-hole 396 is configured to receive the third pivot pin 342C and to pivot thereabout.

The second link member 346 has a generally L-shaped outer shape with a first leg 400 connected to a second leg 402 by a bent portion 404. The first leg 400 extends longitudinally and has a free end portion 406 with a laterally extending through-hole 408 formed therein. The through-hole 408 is configured to receive and rotate about the fifth pivot pin 342E. The second leg 402 extends laterally and has a laterally extending through-channel 410 formed therein. Thus, the second leg 402 may be characterized as being a collar that surrounds the through-channel 410. The through-channel 410 is configured to receive and rotate about the second pivot pin 342B.

The lever 348 has an upper end 412 opposite a lower end 414. The lever 348 has an outwardly facing side 420 opposite an inwardly facing side 422. The outwardly facing side 420 faces toward the active door 110 (see FIGS. 1A-2) and the inwardly facing side 422 faces toward the chassis 340.

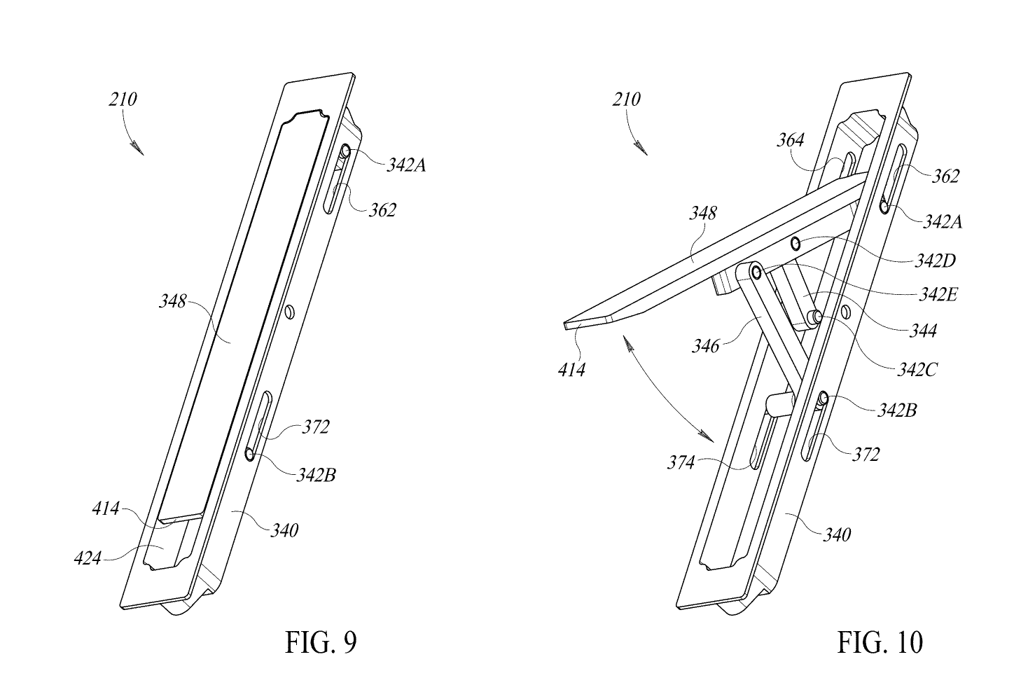

Referring to FIG. 9, the lever 348 may be shorter than the chassis 340 to allow a space 424 through which a user can insert his/her finger(s) into the hollow interior 350 (see FIG. 6) of the chassis 340, grip the lower end 414 of the lever 348, and pull outwardly on the lower end 414 of the lever 348, which causes the lever 348 to pivot about the first pivot pin 342A (as shown in FIG. 10) into an unlocked position (see FIG. 10). Referring to FIG. 8, at the lower end 414, the inwardly facing side 422 may have a relieved grip portion 426 to make it easier for the user to grip the lever 348.

The inwardly facing side 422 of the lever 348 has an inwardly extending portion 328. The inwardly extending portion 328 has a wider portion 427 that is positioned at or near the upper end 412 and is connected to a narrower portion 429 that extends from the wider portion 427 partway toward the lower end 414. Referring to FIG. 6, the wider portion 427 has a laterally extending through-hole 430 configured to receive the first pivot pin 342A. The first pivot pin 342A both rotatably and slideably couples the lever 348 to the chassis 340. The narrower portion 429 has laterally extending through-holes 432 and 434 (see FIGS. 8 and 9) configured to receive the fourth and fifth pivot pins 342D and 342E, respectively. Referring to FIG. 10, the fourth pivot pin 342D rotatably couples the lever 348 to the first link member 344, which is rotatably coupled to the chassis 340 by the third pivot pin 342C. The fifth pivot pin 342E rotatably couples the lever 348 to the second link member 346, which is both rotatably and slideably coupled to the chassis 340 by the second pivot pin 342B. Referring to FIG. 8, optionally, the narrower portion 429 may include a groove 436 configured to receive an end portion of the third pivot pin 342C that optionally extends outwardly from the second through-hole 396 (see FIG. 6) of the first link member 344 when the lever 348 is in a locked position (see FIG. 9).

### Connecting Rods

Referring to FIG. 3, the upper and lower connecting rods 220 and 222 are each substantially linear and extend within the channel 270 substantially parallel with the longitudinal axis “L.” In the embodiment illustrated, the upper connecting rod 220 is shorter than the lower connecting rod 222. However, in alternate embodiments, the upper connecting rod 220 may be longer than the lower connecting rod 222 or the upper and lower connecting rods 220 and 222 may have equal lengths. In the embodiment illustrated, the upper and lower connecting rods 220 and 222 each have a substantially circular lateral cross-sectional shape. However, this is not a requirement.

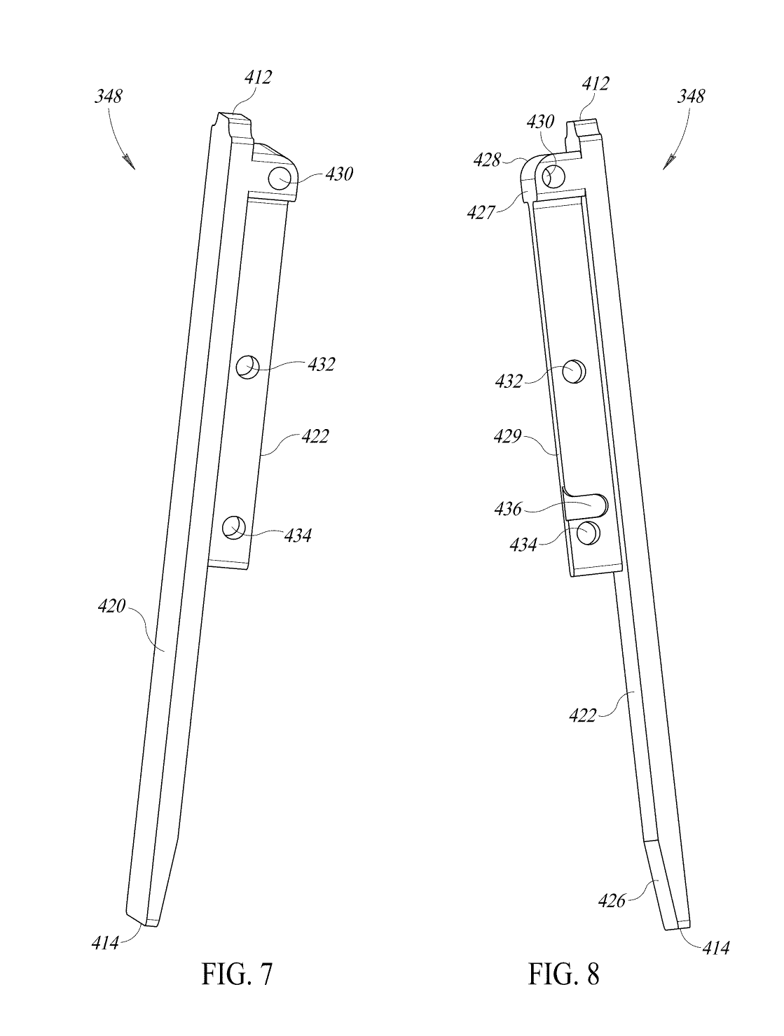

The upper connecting rod 220 has a distal end portion 450 opposite a proximal end portion 452. The distal end portion 450 may include outside threads 454. Referring to FIG. 11, the proximal end portion 452 includes a through-hole 456 configured to receive the first pivot pin 342A, which is rotatable inside the through-hole 430 (see FIGS. 6-8). The upper connecting rod 220 is configured to be positioned inside the channel 270 and to extend upwardly therein away from the lever assembly 210 with the first pivot pin 342A received inside the through-hole 456. When the first pivot pin 342A slides upwardly within the first and second upper through-slots 362 and 364 (see FIGS. 6 and 10), the upper connecting rod 220 slides upwardly (or distally) within the channel 270. Similarly, when the first pivot pin 342A slides downwardly within the first and second upper through-slots 362 and 364 (see FIGS. 6 and 10), the upper connecting rod 220 slides downwardly (or proximally) within the channel 270.

Referring to FIG. 3, the lower connecting rod 222 has a distal end portion 460 opposite a proximal end portion 462. The distal end portion 460 may include outside threads 464. Referring to FIG. 11, the proximal end portion 462 includes a through-hole 466 configured to receive the second pivot pin 342B, which is rotatable inside the through-hole 466. The lower connecting rod 222 is configured to be positioned inside the channel 270 and to extend downwardly therein away from the lever assembly 210 with the second pivot pin 342B received inside the through-hole 466. When the second pivot pin 342B slides downwardly within the first and second lower through-slots 372 and 374 (see FIGS. 6 and 10), the lower connecting rod 222 slides downwardly (or distally) within the channel 270. Similarly, when the second pivot pin 342B slides upwardly within the first and second lower through-slots 372 and 374 (see FIGS. 6 and 10), the lower connecting rod 222 slides upwardly (or proximally) within the channel 270.

Referring to FIG. 10, as mentioned above, the lever 348 is configured to be operated manually by the user. To place the astragal assembly 100 in the unlocked configuration (see FIGS. 1B, 18B, and 19B), the user grasps the lower end 414 of the lever 348 and pulls it outwardly away from the chassis 340 into the unlocked position (illustrated in FIG. 10). This causes the first pivot pin 342A to rotate within the first and second upper slots 362 and 364. At the same time, the third pivot pin 342C rotates in the second intermediate through-hole 384 (see FIG. 6). The third pivot pin 342C is connected to the first link member 344, which is rotatably connected to the fourth pivot pin 342D. However, neither the third pivot pin 342C nor the fourth pivot pin 342D slides with respect to either the lever 348 or the chassis 340. Thus, the first pivot pin 342A is forced to slide in the first and second upper slots 362 and 364 with respect to the chassis 340. The second link member 346 is connected to the lever 348 by the fifth pivot pin 342E and to the chassis 340 by the second pivot pin 342B. When the first pivot pin 342A slides with respect to the chassis 340, the second pivot pin 342B is forced to slide within the first and second lower slots 372 and 374 by the second link member 346. The first pivot pin 342A slides downwardly pulling the upper connecting rod 220 (see FIGS. 3, 11, 13A, and 21) downwardly (or proximally). The second pivot pin 342B slides upwardly pulling the lower connecting rod 222 (see FIGS. 3, 11, and 13B) upwardly (or proximally). When the first pivot pin 342A can no longer slide downwardly in the first and second upper slots 362 and 364 and/or the second pivot pin 342B can no longer slide upwardly in the first and second lower slots 372 and 374, the astragal assembly 100 is in the fully unlocked configuration (see FIGS. 1B, 18B, and 19B).

To place the astragal assembly 100 in the locked configuration (see FIGS. 1A, 18A, and 19A), the user grasps the lower end 414 of the lever 348 and pushes it toward the chassis 340 and into the locked position (see FIG. 9). This causes the first pivot pin 342A to rotate within the first and second upper slots 362 and 364. At the same time, the third pivot pin 342C rotates in the second intermediate through-hole 384 (see FIG. 6). Thus, the first pivot pin 342A is forced to slide upwardly with respect to the chassis 340. When the first pivot pin 342A slides upwardly with respect to the chassis 340, the second pivot pin 342B is forced to slide downwardly within the first and second lower slots 372 and 374 by the second link member 346. As the first pivot pin 342A slides upwardly, the first pivot pin 342A pushes the upper connecting rod 220 (see FIGS. 3, 11, 13A, and 21) upwardly (or distally). As the second pivot pin 342B slides downwardly, the second pivot pin 342B pushes the lower connecting rod 222 (see FIGS. 3, 11, and 13B) downwardly (or distally). When the first pivot pin 342A can no longer slide upwardly in the first and second upper slots 362 and 364 and/or the second pivot pin 342B can no longer slide downwardly in the first and second lower slots 372 and 374, the astragal assembly 100 is in the fully locked configuration (see FIGS. 1A, 18A, and 19A). Referring to FIG. 1A, if the passive door 120 is in the closed position, the astragal assembly 100 locks the passive door 120 in the closed position when the astragal assembly 100 is in the locked configuration.

### Slide Bolt Assemblies

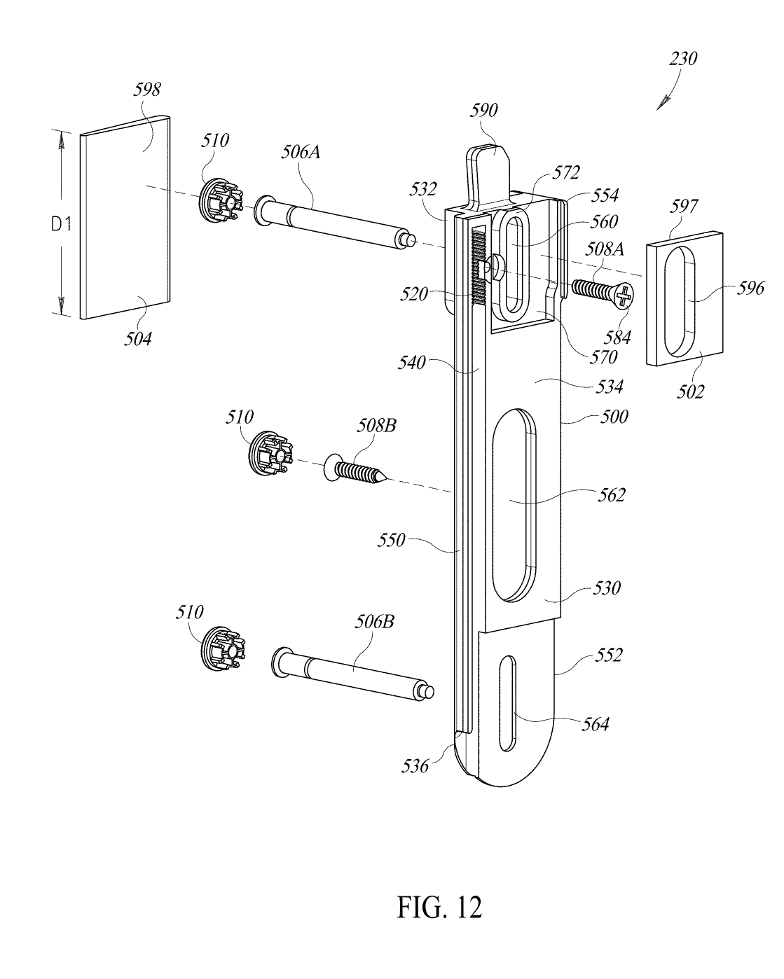

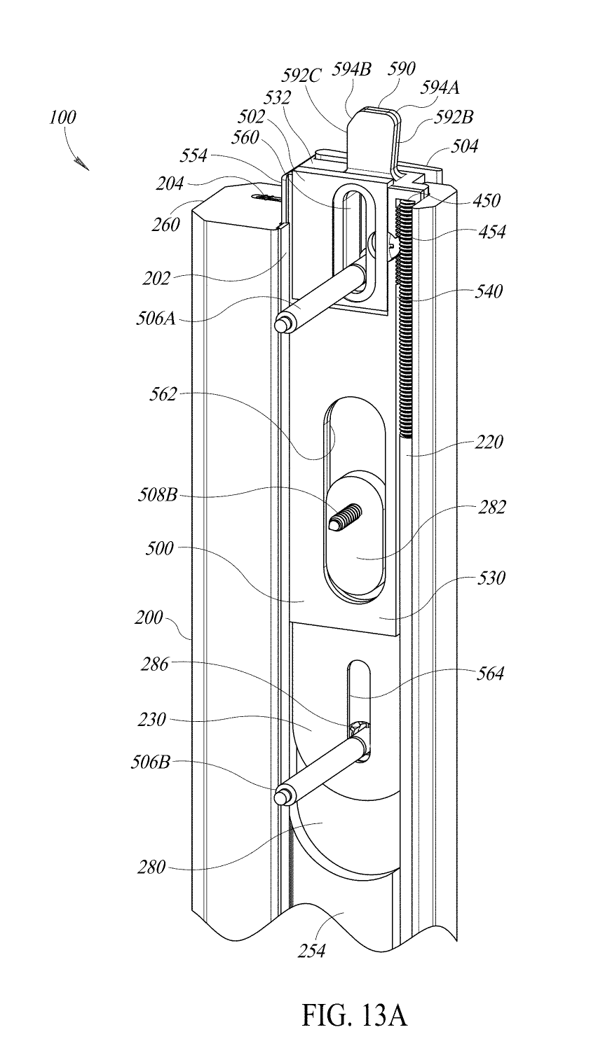

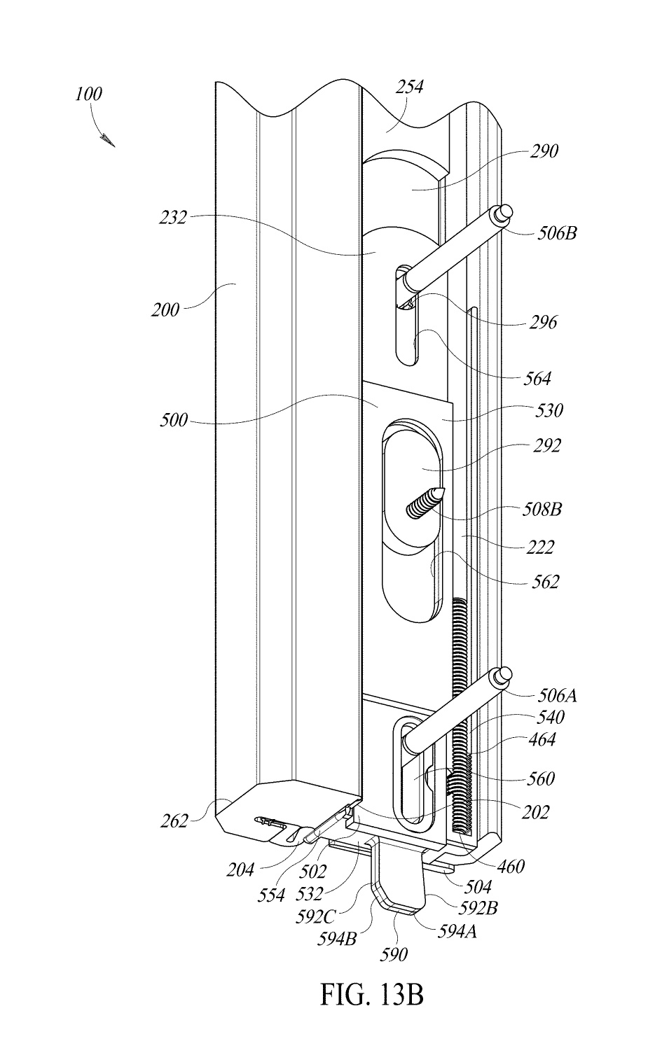

Referring to FIG. 3, the upper and lower slide bolt assemblies 230 and 232 are substantially identical to one another. Referring to FIG. 12, the upper and lower slide bolt assemblies 230 and 232 (see FIG. 3) each includes a shoot bolt member 500, a slide bolt gasket 502, a slide bolt pad 504, pins 506A and 506B, and fasteners 508A and 508B. Optionally, plugs 510 may be used to hide the pins 506A and 506B and the fastener 508B. Referring to FIG. 13A, the shoot bolt member 500 of the upper slide bolt assembly 230 is configured to be positioned and slide within the upper recess 280 of the astragal body 200. Referring to FIG. 3, the shoot bolt member 500 of the upper slide bolt assembly 230 moves with the upper connecting rod 220 as a unit when the upper connecting rod 220 is slid upwardly or downwardly by the lever 348 (see FIGS. 6-10). Similarly, referring to FIG. 13B, the shoot bolt member 500 of the lower slide bolt assembly 232 is configured to be positioned and slide within the lower recess 290 of the astragal body 200. The shoot bolt member 500 of the lower slide bolt assembly 232 moves with the lower connecting rod 222 as a unit when the lower connecting rod 222 is slid upwardly or downwardly by the lever 348 (see FIGS. 6-10).

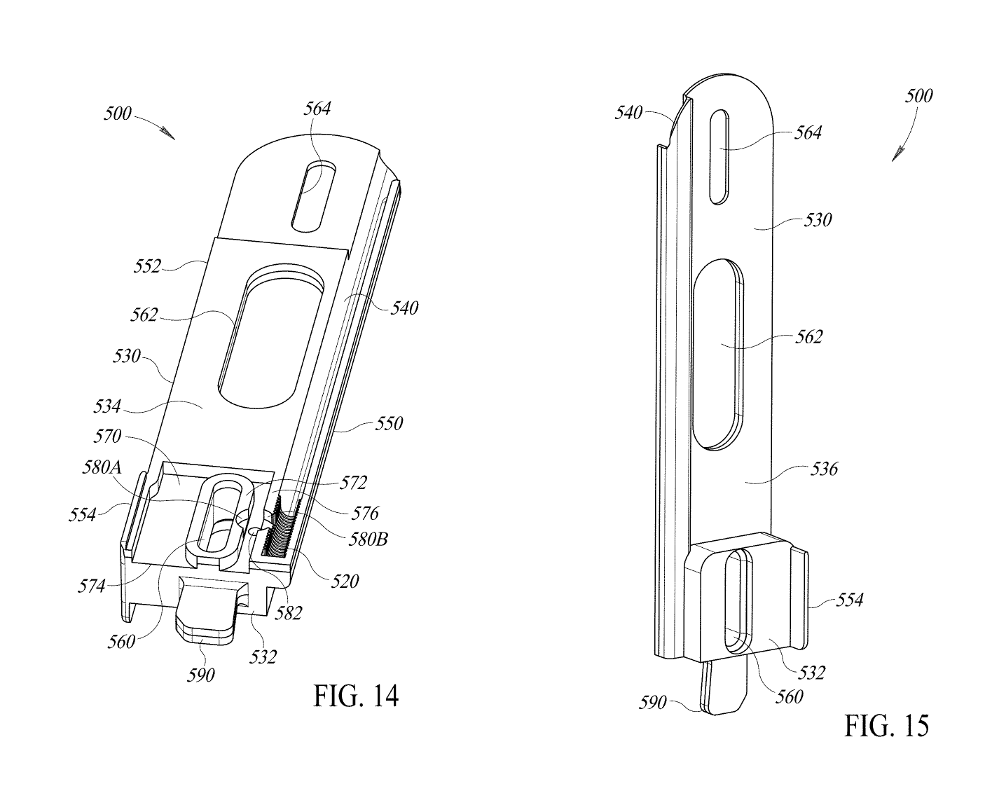

Referring to FIG. 12, the shoot bolt member 500 has a body portion 530 and a bolt portion 532. The body portion 530 has an inwardly facing side 534 opposite an outwardly facing side 536. The bolt portion 532 is attached to the body portion 530 along its outwardly facing side 536. Referring to FIG. 15, the outwardly facing side 536 of the shoot bolt member 500 of the upper and lower slide bolt assemblies 230 and 232 (see FIG. 3) faces toward and slides along the astragal body 200 (see FIGS. 3-5, 11, 13A, 13B, and 18A-21). Referring to FIG. 14, the inwardly facing side 534 of the shoot bolt member 500 of the upper and lower slide bolt assemblies 230 and 232 (see FIG. 3) faces toward and slides along the passive door 120 (see FIGS. 1A-2 and 21).

The inwardly facing side 534 has a channel 540 formed therein. The channel 540 of the upper slide bolt assembly 230 is configured to receive the upper connecting rod 220 (see FIGS. 3, 11, 13A, and 21). Referring to FIG. 13A, the distal end portion 450 of the upper connecting rod 220 may be press-fit into the channel 540 of the upper slide bolt assembly 230. This process may cause inside threads 520 (see FIGS. 12 and 14) to be formed inside the channel 540 of the upper slide bolt assembly 230. The press-fit couples the upper connecting rod 220 and the shoot bolt member 500 of the upper slide bolt assembly 230 together. Alternatively, the inside threads 520 may be molded into the channel 540 of the upper slide bolt assembly 230. In such embodiments, the inside threads 520 are configured to threadly engage the outside threads 454 of the upper connecting rod 220. In other words, the outside threads 454 of the upper connecting rod 220 are configured to be threaded into the inside threads 520 of the upper slide bolt assembly 230.

Similarly, the channel 540 of the lower slide bolt assembly 232 is configured to receive the lower connecting rod 222. Referring to FIG. 13B, the distal end portion 460 of the lower connecting rod 222 may be press-fit into the channel 540 of the lower slide bolt assembly 232. Optionally, this may cause the inside threads 520 (see FIGS. 12 and 14) to be formed inside the channel 540 of the lower slide bolt assembly 232. The press-fit couples the lower connecting rod 222 and the shoot bolt member 500 of the lower slide bolt assembly 232 together. Alternatively, the inside threads 520 may be molded into the channel 540 of the lower slide bolt assembly 232. In such embodiments, the inside threads 520 are configured to threadly engage the outside threads 454 of the lower connecting rod 222. In other words, the outside threads 454 of the lower connecting rod 222 are configured to be threaded into the inside threads 520 of the lower slide bolt assembly 232.

Referring to FIG. 14, the body portion 530 of the shoot bolt member 500 has a first side 550 opposite a second side 552. The channel 540 is formed along the first side 550 and a sidewall 554 is formed along the second side 552. Referring to FIG. 12, the sidewall 554 extends outwardly beyond the inwardly and outwardly facing sides 534 and 536. In the embodiment illustrated, the sidewall 554 also extends outwardly beyond the bolt portion 532.

Referring to FIG. 3, the bolt portion 532 (see FIGS. 12-15 and 18A-19B) of the upper slide bolt assembly 230 is configured to be positioned inside the distal through-hole 284 of the astragal body 200 and to slide upwardly and downwardly therein. Similarly, the bolt portion 532 (see FIGS. 12-15 and 18A-19B) of the lower slide bolt assembly 232 is configured to be positioned inside the distal through-hole 294 of the astragal body 200 and to slide upwardly and downwardly therein. The slide bolt pad 504 is configured to be positioned alongside the bolt portion 532 and to abut the sidewall 554. The slide bolt pad 504 is generally wedge shaped and is thicker nearer the sidewall 554 than the channel 540. Referring to FIGS. 13A and 13B, the longitudinally extending sidewall 554 of the upper and lower slide bolt assemblies 230 and 232 prevents the slide bolt gasket 502 and the slide bolt pad 504 from rubbing against the astragal body 200 when the shoot bolt member 500 slides upwardly and downwardly therealong.

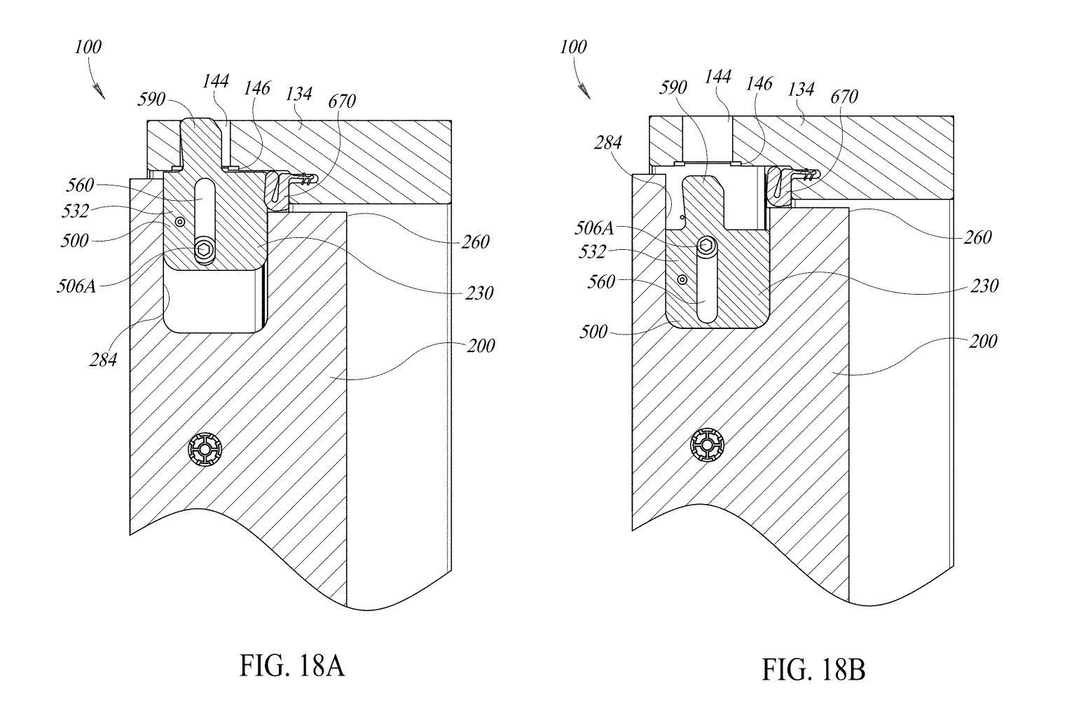

The shoot bolt member 500 of the upper slide bolt assembly 230 compresses the slide bolt gasket 502 and/or the slide bolt pad 504 against the header member 134 (see FIGS. 1A-3, 18A, and 18B) when the shoot bolt member 500 is positioned distally along the astragal body 200 (as illustrated in FIGS. 13A and 18A). Similarly, the shoot bolt member 500 of the lower slide bolt assembly 232 (see FIGS. 3, 13B, 19A, and 19B) compresses the slide bolt gasket 502 and/or the slide bolt pad 504 against the sill member 132 (see FIGS. 1-3, 16, 19A, and 19B) when the shoot bolt member 500 is positioned distally along the astragal body 200 (as illustrated in FIGS. 13B and 19A).

Referring to FIG. 12, the shoot bolt member 500 has distal, intermediate, and proximal through-slots 560, 562, and 564. The distal through-slot 560 extends through both the body and bolt portions 530 and 532. Referring to FIG. 3, the distal through-slots 560 (see FIGS. 12-15 and 18A-19B) of the upper and lower slide bolt assemblies 230 and 232 are positioned within the distal through-holes 284 and 294, respectively, of the astragal body 200. Referring to FIG. 12, the first pin 506A is configured to be received inside the distal through-slot 560 and to extend therethrough into the passive door 120 (see FIGS. 1A-2 and 21). The passive door 120 maintains the first pin 506A in a substantially stationary position. Referring to FIG. 13A, the distal through-slot 560 slides along the first pin 506A when the shoot bolt member 500 slides upwardly and downwardly along the astragal body 200.

Referring to FIG. 12, in the embodiment illustrated, the distal through-slot 560 is surrounded by a recess 570 configured to receive the slide bolt gasket 502. In the embodiment illustrated, referring to FIG. 13A, the recess 570 is open along its distal edge 574 (see FIG. 14) allowing the slide bolt gasket 502 of the upper slide bolt assembly 230 to contact the header member 134 (see FIGS. 1A-3, 18A, and 18B). Referring to FIG. 13B, at the same time, the open distal edge 574 (see FIG. 14) allows the slide bolt gasket 502 of the lower slide bolt assembly 232 to contact the sill member 132 (see FIGS. 1-3, 16, 19A, and 19B).

Referring to FIG. 14, the recess 570 is separated from the channel 540 by a longitudinally extending sidewall 576. Referring to FIG. 13A, the longitudinally extending sidewall 576 (see FIG. 14) of the upper slide bolt assembly 230 separates the upper connecting rod 220 from the slide bolt gasket 502. Similarly, referring to FIG. 13B, the longitudinally extending sidewall 576 (see FIG. 14) of the lower slide bolt assembly 232 separates the lower connecting rod 222 from the slide bolt gasket 502. Referring to FIG. 14, the distal through-slot 560 is surrounded by an outwardly extending sidewall 572. The sidewalls 572 and 576 may include relieved portions 580A and 580B, respectively, that surround a through-hole 582 configured to receive the fastener 508A (see FIG. 12). The fastener 508A may have a head 584 (see FIG. 12) that is recessed inside the relieved portions 580A and 580B.

Referring to FIG. 13A, the intermediate through-slot 562 of the upper slide bolt assembly 230 is configured to receive the upper guide projection 282. The intermediate through-slot 562 of the upper slide bolt assembly 230 is longer than the upper guide projection 282 along the longitudinal axis “L” (see FIG. 3) so that the intermediate through-slot 562 slides along the upper guide projection 282. Similarly, referring to FIG. 13B, the intermediate through-slot 562 of the lower slide bolt assembly 232 is configured to receive the lower guide projection 292. The intermediate through-slot 562 of the lower slide bolt assembly 232 is longer than the lower guide projection 292 along the longitudinal axis “L” (see FIG. 3) so that the intermediate through-slot 562 slides along the lower guide projection 292.

Referring to FIG. 13A, the proximal through-slot 564 of the upper slide bolt assembly 230 is configured to be positioned alongside and aligned with the proximal through-hole 286 of the astragal body 200. The second pin 506B of the upper slide bolt assembly 230 is configured to be received inside the aligned proximal through-slot 564 and the proximal through-hole 286 and to extend into the passive door 120 (see FIGS. 1A-2 and 21). The passive door 120 maintains the second pin 506B in a substantially stationary position. The proximal through-slot 564 slides along the second pin 506B when the shoot bolt member 500 of the upper slide bolt assembly 230 slides upwardly and downwardly.

Referring to FIG. 13B, the proximal through-slot 564 of the lower slide bolt assembly 232 is configured to be positioned alongside and aligned with the proximal through-hole 296 of the astragal body 200. The second pin 506B of the lower slide bolt assembly 232 is configured to be received inside the aligned proximal through-slot 564 and the proximal through-hole 296 and to extend into the passive door 120 (see FIGS. 1A-2 and 21). The passive door 120 maintains the second pin 506B in a substantially stationary position. The proximal through-slot 564 slides along the second pin 506B when the shoot bolt member 500 of the lower slide bolt assembly 232 slides upwardly and downwardly.

Referring to FIGS. 13A and 13B, the bolt portion 532 has a distally extending projection 590. The projection 590 has a distal edge 592A and first and second longitudinally extending edges 592B and 592C. The first edge 592B is opposite the second edge 592C. At the intersection of the distal edge 592A and the first edge 592B, the projection 590 has a relieved, chamfered, or beveled corner portion 594A. At the intersection of the distal edge 592A and the second edge 592C, the projection 590 has a relieved, chamfered, or beveled corner portion 594B. In the embodiment illustrated, the corner portion 594B is relieved more than the corner portion 594A.

Referring to FIG. 12, the recess 570 of the shoot bolt member 500 indicates the proper location for installation of the slide bolt gasket 502. The slide bolt gasket 502 may be installed at the factory. The slide bolt gasket 502 may have a generally rectangular outer shape. The slide bolt gasket 502 has a through-hole 596 configured to allow access to the distal through-slot 560. In the embodiment illustrated, the through-hole 596 is configured to receive the sidewall 572. The slide bolt gasket 502 may be constructed from ethylene-propylene-diene-monomer (“EPDM”). The slide bolt gasket 502 may have a layer of adhesive (e.g., pressure sensitive adhesive) applied to a shoot bolt member facing side 597 of the slide bolt gasket 502. A layer of removable paper may be affixed to the layer of adhesive before the slide bolt gasket 502 is attached to the shoot bolt member 500. The layer of paper may be removed and the layer of adhesive affixed to the shoot bolt member 500 inside the recess 570. The slide bolt gasket 502 may be die cut.

The sidewall 554 of the shoot bolt member 500 partially indicates the proper location for installation of the slide bolt pad 504. The slide bolt pad 504 may be installed at the factory, because its proper placement may help avoid light, air, and/or water from leaking through the astragal assembly 100 (see FIGS. 1A-3, 13A, 13B, and 18A-21). The slide bolt pad 504 may have a length “Dl” of about 2.5 inches, which is longer than the length (e.g., about 1.75 inches) of currently used corner pads. Referring to FIG. 3, the length “Dl” (see FIG. 12) of the slide bolt pad 504 (see FIGS. 1B, 2, and 12-13B) of the upper slide bolt assembly 230 provides better performance in water than prior art astragal assemblies and covers the distal through-hole 284 formed in the upper end portion 260 of the astragal body 200. Similarly, the length “Dl” (see FIG. 12) of the slide bolt pad 504 (see FIGS. 1B, 2, and 12-13B) of the lower slide bolt assembly 232 provides better performance in water than prior art astragal assemblies and covers the distal through-hole 294 formed in the lower end portion 262 of the astragal body 200

Referring to FIG. 12, the slide bolt pad 504 may have a layer of adhesive (e.g., pressure sensitive adhesive) applied to a side 598 of the slide bolt pad 504. A layer of removable paper may be affixed to the layer of adhesive before the slide bolt pad 504 is attached to the bolt portion 532 of the shoot bolt member 500. The layer of paper may be removed and the layer of adhesive affixed to the shoot bolt member 500.

Both the slide bolt gasket 502 and the slide bolt pad 504 move with the shoot bolt member 500 as a unit when the shoot bolt member 500 slides along the astragal body 200.

### Sill Receiver Assembly

Referring to FIG. 16, the sill receiver assembly 142 includes a sill receiver member 600, a receiver gasket 602, an optional seal member 604, an optional fastener 606, and an optional plug 608.

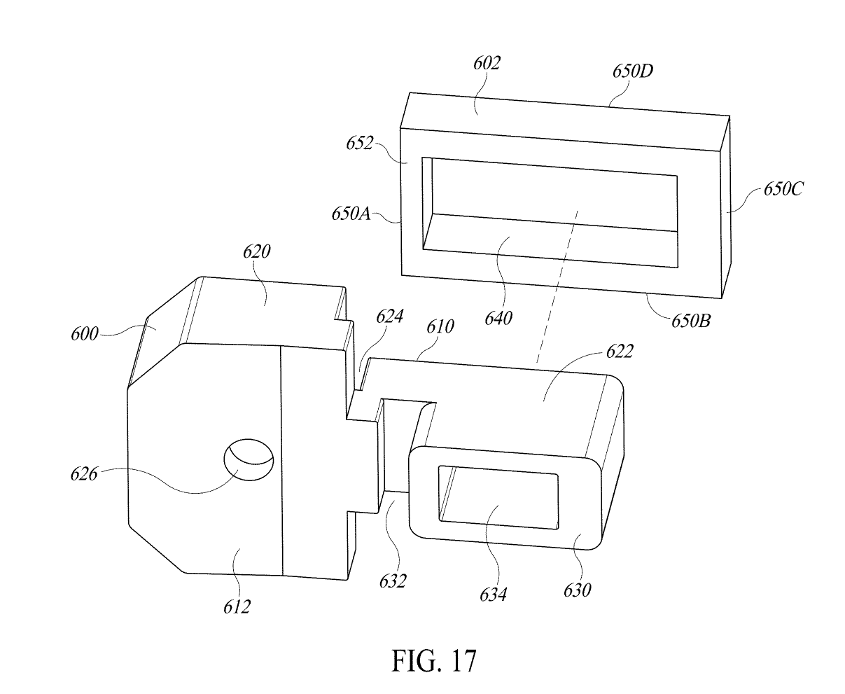

The sill receiver member 600 has an upwardly facing side 610 opposite a downwardly facing side 612. The sill receiver member 600 includes an anchor portion 620 connected to a bolt receiving portion 622. In the embodiment illustrated, referring to FIG. 17, the sill receiver member 600 includes a downwardly extending recess 624 formed in the anchor portion 620 and/or the bolt receiving portion 622 located where the anchor portion 620 is connected to the bolt receiving portion 622.

Referring to FIG. 16, along the anchor portion 620, the downwardly facing side 612 of the sill receiver member 600 is configured to rest upon the upper surface 141 of the sill member 132. The anchor portion 620 includes a through-hole 626 configured to receive the fastener 606, which is inserted therein from the upwardly facing side 610. In the embodiment illustrated, the through-hole 626 is also configured to receive the optional plug 608, which is visible along the upwardly facing side 610. In the embodiment illustrated, the upper surface 141 of the sill member 132 includes a through-hole 614 that may be formed by the fastener 606 or may be pre-drilled in the sill member 132 and configured to receive the fastener 606.

The bolt receiving portion 622 includes a downwardly extending lower portion 630 configured to be received inside the recess 140 formed in the upper surface 141 of the sill member 132. In the embodiment illustrated, the underside of the bolt receiving portion 622 may be shaped and/or contoured to traverse a profile shape formed in the upper surface 141 of the sill member 132. For example, the underside may include an upwardly extending recess 632 configured to traverse a ridge 633 formed in the upper surface 141 of the sill member 132. Referring to FIGS. 19A and 19B, the bolt receiving portion 622 has a downwardly extending opening or through-slot 634 configured to receive the projection 590 of the lower slide bolt assembly 232 when the shoot bolt member 500 is positioned distally along the astragal body 200 (as illustrated in FIGS. 13B and 19A).

Returning to FIG. 16, the receiver gasket 602 has a through-hole 640 configured to receive the bolt receiving portion 622 therein. In the embodiment illustrated, both the receiver gasket 602 and the through-hole 640 have generally rectangular shaped outer shapes defined by sidewalls 650A-650D. The sidewall 650A is configured to be received inside the recess 624 and may optionally be compressed inside the recess 624 when the receiver gasket 602 is installed on the bolt receiving portion 622. However, in some embodiments, it may be necessary to remove the sidewall 650A before the receiver gasket 602 is installed on the bolt receiving portion 622. Thus, in some embodiments, the receiver gasket 602 may have a generally U-shaped outer shape defined by the sidewalls 650B-650D. For example, an Americans with Disabilities Act (“ADA”) compliant version may include two gaskets (each like the receiver gasket 602) with one of the gaskets being modified into a U-shape.

Referring to FIG. 17, the receiver gasket 602 may be constructed from ethylene propylene diene monomer (“EPDM”) rubber and may have a layer of adhesive (e.g., pressure sensitive adhesive) applied to a sill receiver member facing side 652 of the sidewall 650A. A layer of removable paper (not shown) may be affixed to the layer of adhesive before the receiver gasket 602 is attached to the sill receiver member 600. The layer of paper may be removed and the layer of adhesive affixed to the sill receiver member 600 inside the recess 624. Thus, the recess 624 and the outer shape of the bolt receiving portion 622 indicate the proper position for the receiver gasket 602. The receiver gasket 602 may be die cut.

Referring to FIG. 16, the optional seal member 604 may be positioned between the sill receiver member 600 and the upper surface 141 of the sill member 132. The seal member 604 illustrated is substantially planer and has an outer shape that corresponds to the outer shape of the sill receiver member 600. The seal member 604 includes a through-hole 660 configured to allow the lower portion 630 of the sill receiver member 600 to pass therethrough unobstructed and into the recess 140. The seal member 604 may be constructed from 3M VHB double-sided tape having a thickness of about 0.030 inches that is die cut (e.g., kiss cut) into the desired shape.

The sill receiver assembly 142 may help avoid at least some of the problems with prior art astragal assemblies. These problems include, for example, a poor or non-existent seal between the sill and the astragal assembly provided by prior art astragal assemblies, which allows light, water, and/or air to leak through. This places responsibly on the installer for sealing this area. By way of another example, prior art sill receivers may work loose, which leads to worse performance and might cause the sill receiver to interfere with the operation of the active and/or passive door. Sometimes, prior art sill receivers become completely disconnected from the sill, which allows the door(s) to rattle, compromises security, and allows light, water, and/or air to leak therethrough. Some prior art sill receivers use screws for higher performance but these screws must be inserted through an adjustable cap, which disrupts the adjustable cap and may create leaks. Further, sealing prior art sill receivers can negatively affect the adjustability of the sill rail.

The sill receiver assembly 142 may avoid at least some of these problems because responsibly for forming a seal between the sill member 132 and the astragal assembly 100 is not placed on the installer. In fact, the installer does not need to know where to position (or how to seal) the sill receiver assembly 142. Instead, the manufacturer seals the sill receiver assembly 142 by installing the receiver gasket 602 and optionally, the seal member 604. In this way, the manufacturer may ensure the receiver gasket 602 and optionally, the seal member 604 are installed properly and provide an acceptable performance. The sill receiver assembly 142 is positioned between (but is not mechanically connected to) the pair of adjustable rails “R1” and “R2” instead of being positioned on top of a single adjustable rail, which allows independent adjustment of the rails “R1” and “R2” without disrupting the position of the sill receiver assembly 142.

Additional problems experienced by prior art astragal assemblies may be caused by curves or contours formed in an adjustable rail of the sill. Many prior art astragal assemblies include flat seals or gaskets that often fail to conform to these curves or contours. Further, irregularities in the adjustable rail may cause performance or fit issues with the flat seals or gaskets. Vertical positioning of the adjustable rail can create gaps or cause problems with the operation of the passive door. Wood grain of the adjustable rail can create a path through which light, water, and/or air may leak. A groove or hole formed in the adjustable rail can also compromises performance. Also, for reliable resistance to air and water leaks, there must be some pressure between the sill and the flat seals or gaskets. Unfortunately, prior art astragal assemblies typically rely on the user (e.g., a homeowner) to extend (or throw) the shoot bolts far enough to provide this pressure.

The sill receiver assembly 142 may avoid at least some of these problems because the receiver gasket 602 is attached to the sill receiver member 600, which is attached to the sill member 132. Thus, the receiver gasket 602 is unaffected by curves, contours, irregularities, etc. formed in the sill member 132 and/or the adjustable rails “R1” and “R2.” Further, a plane on the top of the receiver gasket 602 is elevated above the upper surface 141 of the sill member 132 and the adjustable rails “R1” and “R2.” This elevated plane creates a dam that helps prevent water from passing underneath the astragal assembly 100. The receiver gasket 602 and the receiver gasket 602 meet on the plane (or a non-curved surface), which provides a reliable seal against light, air, and/or water. The lever 348 compresses the slide bolt gasket 502 and the slide bolt pad 504 of the lower slide bolt assembly 232 against the sill receiver gasket for reliable performance along the sill member 132. Additionally, the lever 348 compresses the slide bolt gasket 502 and the slide bolt pad 504 of the upper slide bolt assembly 230 against the header member 134 for reliable performance along the header member 134.

Problems may also be experienced by prior art astragal assemblies because the inswing adjustable rail cannot be adjusted independently of the sill receiver. Specifically, inswing adjustable sills include a sill receiver that is mounted integrally with the adjustable rail. Thus, adjusting the adjustable rail necessarily changes the location of the sill receiver. Optimizing the location of the adjustable rail for the sill receiver (or vice versa) can compromise performance of a door sweep mounted on a lower edge of the active and/or passive doors. The door sweep mounted on the active door wears differently than the door sweep mounted on the passive door. Homeowners commonly replace door sweeps with a door sweep manufactured by a third party, which may require a different gap between sill and door(s). Optimizing the gap with respect to one of the doors can compromises the seal between the astragal assembly and the other door.

The sill receiver assembly 142 may avoid at least some of these problems because the sill receiver assembly 142 is positioned between the adjustable rails “R1” and “R2,” which allows independent adjustment of each of the adjustable rails “R1” and “R2.” Thus, a seal may be formed between the active door 110 and the adjustable rail “R1” without affecting a seal formed between the passive door 120 and the adjustable rail “R2.” Thus, service personnel may fix a leak without causing another leak. Also, the user can enjoy reliable performance even if the user replaces an original (manufacturer installed) door sweep with a third party door sweep.

### Operation

FIG. 18A illustrates the shoot bolt member 500 of the upper slide bolt assembly 230 in the distal position when the passive door 120 (see FIGS. 1A-2 and 21) is in the closed position (see FIG. 1). Thus, FIG. 18A illustrates the upper slide bolt assembly 230 when the astragal assembly 100 is in the locked configuration (see also FIGS. 1A and 19A). In the locked configuration, the projection 590 is received inside the slot 144 formed in the header member 134 and surrounded by the strike plate 146. Referring to FIG. 13A, the slide bolt gasket 502 and the slide bolt pad 504 are both pressed against the header member 134 (see FIGS. 1A-3, 18A, and 18B) and form a seal therewith. Referring to FIG. 18A, the shoot bolt member 500 may press against weather-stripping 670 mounted on the header member 134, which may provide an additional seal.

FIG. 18B illustrates the shoot bolt member 500 of the upper slide bolt assembly 230 in the proximal position when the passive door 120 (see FIGS. 1A-2 and 21) is in the closed position (see FIG. 1). Thus, FIG. 18B illustrates the upper slide bolt assembly 230 when the astragal assembly 100 is in the unlocked configuration (see also FIGS. 1B and 19B), in which the passive door 120 (see FIGS. 1A-2 and 21) may be opened (see FIGS. 1B and 2). In the unlocked configuration, the projection 590 is spaced apart from the slot 144 and the shoot bolt member 500 no longer presses against the weather-stripping 670. Thus, the projection 590 no longer prevents the passive door 120 from being opened. Also, referring to FIG. 13A, the slide bolt gasket 502 and the slide bolt pad 504 are both spaced apart from the header member 134 (see FIGS. 1A-3, 18A, and 18B) and no longer form a seal therewith.

FIG. 19A illustrates the shoot bolt member 500 of the lower slide bolt assembly 232 in the distal position when the passive door 120 (see FIGS. 1A-2 and 21) is in the closed position (see FIG. 1). Thus, FIG. 19A illustrates the lower slide bolt assembly 232 when the astragal assembly 100 is in the locked configuration (see also FIGS. 1A and 18A). In the locked configuration, the projection 590 is received inside the through-slot 634 of the sill receiver member 600 of the sill receiver assembly 142. The bolt portion 532 and/or a distal portion of the body portion 530 of the shoot bolt member 500 may press downwardly against the receiver gasket 602 mounted on the sill receiver member 600. As mentioned above, referring to FIG. 13B, the slide bolt gasket 502 and/or the slide bolt pad 504 may press downwardly against the receiver gasket 602 (see FIGS. 16, 17, 19A, and 19B) and form a seal therewith.

FIG. 19B illustrates the shoot bolt member 500 of the lower slide bolt assembly 232 in the proximal position when the passive door 120 (see FIGS. 1A-2 and 21) is in the closed position (see FIG. 1). Thus, FIG. 19B illustrates the lower slide bolt assembly 232 when the astragal assembly 100 is in the unlocked configuration (see also FIGS. 1B and 18B), in which the passive door 120 (see FIGS. 1A-2 and 21) may be opened (see FIGS. 1B and 2). In the unlocked configuration, the projection 590 is spaced apart from the through-slot 634 and neither the bolt portion 532 nor the distal portion of the body portion 530 presses downwardly against the receiver gasket 602. Further, referring to FIG. 13B, both the slide bolt gasket 502 and the slide bolt pad 504 no longer press downwardly against the receiver gasket 602 (see FIGS. 16, 17, 19A, and 19B). Thus, referring to FIG. 19B, the projection 590 no longer prevents the passive door 120 (see FIGS. 1A-2 and 21) from being opened and the receiver gasket 602 does not interfere with or obstruct the opening of the passive door 120.

Referring to FIG. 3, when the shoot bolt members 500 of the upper and lower slide bolt assemblies 230 and 232 are in their distal positions illustrated in FIGS. 18A and 19A, respectively, the lever 348 (see FIGS. 6-10) of the lever assembly 210 is in the locked position illustrated in FIG. 9. Referring to FIG. 3, when the lever 348 is in the locked position, the lever assembly 210 forces the upper connecting rod 220 to remain in an upward position and forces the lower connecting rod 222 to remain in a downward position. The upper slide bolt assembly 230 is maintained in the distal position by the upper connecting rod 220 and the lower slide bolt assembly 232 is maintained in the distal position by the lower connecting rod 222.

On the other hand, when the shoot bolt members 500 of the upper and lower slide bolt assemblies 230 and 232 are in their proximal positions illustrated in FIGS. 18B and 19B, respectively, the lever 348 (see FIGS. 6-10) of the lever assembly 210 is in the unlocked position illustrated in FIG. 10. Referring to FIG. 3, when the lever 348 is in the unlocked position, the lever assembly 210 forces the upper connecting rod 220 to remain in a downward position and forces the lower connecting rod 222 to remain in an upward position. The upper slide bolt assembly 230 is maintained in the proximal position by the upper connecting rod 220 and the lower slide bolt assembly 232 is maintained in the proximal position by the lower connecting rod 222.

The upper and lower slide bolt assemblies 230 and 232 may be transitioned from their distal positions to their proximal positions by transitioning the lever 348 (see FIGS. 6-10) of the lever assembly 210 from the locked position illustrated in FIG. 9 to the unlocked position illustrated in FIG. 10. As the lever 348 is transitioned (as described above), the upper connecting rod 220 is forced downwardly toward its downward position and the lower connecting rod 222 is forced upwardly toward its upward position. As the upper connecting rod 220 moves downwardly, the upper slide bolt assembly 230 moves therewith until the shoot bolt member 500 of the upper slide bolt assembly 230 is in the proximal position depicted in FIG. 19A. As the lower connecting rod 222 moves upwardly, the lower slide bolt assembly 232 moves therewith until the shoot bolt member 500 of the lower slide bolt assembly 232 is in the proximal position depicted in FIG. 19A.

On the other hand, the upper and lower slide bolt assemblies 230 and 232 may be transitioned from their proximal positions to their distal positions by transitioning the lever 348 (see FIGS. 6-10) of the lever assembly 210 from the unlocked position illustrated in FIG. 10 to the locked position illustrated in FIG. 9. As the lever 348 is transitioned (as described above), the upper connecting rod 220 is forced upwardly toward its upward position and the lower connecting rod 222 is forced downwardly toward its downward position. As the upper connecting rod 220 moves upwardly, the upper slide bolt assembly 230 moves therewith until the shoot bolt member 500 of the upper slide bolt assembly 230 is in the distal position depicted in FIGS. 13A and 18A. As the lower connecting rod 222 moves downwardly, the lower slide bolt assembly 232 moves therewith until the shoot bolt member 500 of the lower slide bolt assembly 232 is in the distal position depicted in FIGS. 13B and 19A.

### Optional Reinforcement Member

Prior art astragal assemblies are not easy to optimize for material strength. Because different building codes require different strengths in different regions, prior art astragal assemblies require unique and specialized parts to achieve the desired strength. Unfortunately, if any of these parts must be replaced, it is difficult to ensure that similar high performance parts are used instead of standard parts. Additionally, prior art astragal assemblies manufactured to have twice the strength typically costs twice as much and require more assembly labor and training.

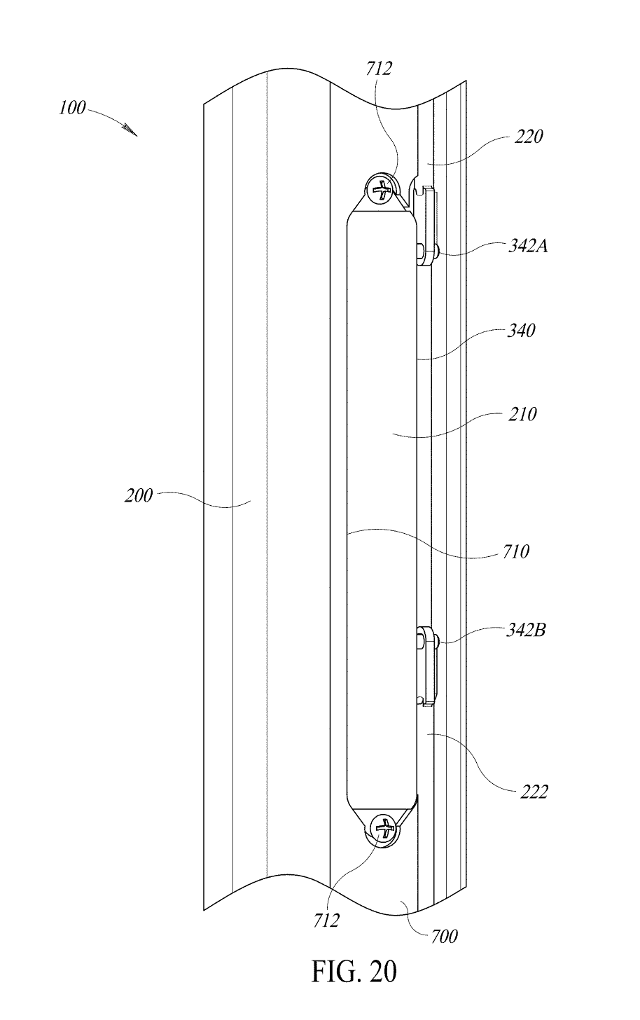

Referring to FIG. 20, the astragal assembly 100 may be made stronger by an optional reinforcement member 700 configured to help stiffen the astragal assembly 100. The reinforcement member 700 is configured to extend along the first side 240 (see FIGS. 3-5 and 11) of the astragal body 200 along the longitudinal axis “L” (see FIG. 3). The reinforcement member 700 may have a through-hole 710 formed therein. The reinforcement member 700 may be coupled to the astragal body 200 by one or more fasteners 712 (e.g., each like the fastener(s) 349 illustrated in FIGS. 3 and 11). If necessary, referring to FIG. 4, material (e.g., about ⅛ inches) may be removed from the connecting portion 254 along the (hidden) first side 240 of the astragal body 200 to provide space for the reinforcement member 700 (see FIGS. 20 and 21).

Referring to FIG. 20, by way of a non-limiting example, the reinforcement member 700 may be constructed from a plate (e.g., having a thickness 0.125 inches) of Aluminum 6061-T651 having a mill finish. By way of a non-limiting example, each of the fastener(s) 712 may be implemented as a flat head screw (e.g., a #8×0.5 inch flat head screw). Referring to FIG. 11, the fastener(s) 712 (see FIG. 20) may be screwed into the opening(s) 347 formed in the chassis 340 of the lever assembly 210. Referring to FIG. 20, in such embodiments, the fastener(s) 712 fasten the chassis 340 to the astragal body 200 within the aperture 300 (see FIGS. 3 and 11).

FIG. 21 is a cross-section of the reinforcement member 700 taken through the pin 506B of the upper slide bolt assembly 230 (see FIGS. 3, 12, 13A, 18A, and 18B). The reinforcement member 700 is positioned alongside the free edge 176 of the passive door 120. As shown in FIG. 21, the reinforcement member 700 may overhang at least a portion of the upper recess 280 formed in the upper end portion 260 (see FIGS. 3-5, 13A, 18A, and 18B) of the astragal body 200. Referring to FIG. 3, similarly, the reinforcement member 700 (see FIGS. 20 and 21) may overhang at least a portion of the lower recess 290 formed in the lower end portion 262 of the astragal body 200. However, this is not a requirement.

By using the reinforcement member 700, different levels of reinforcement may be used with different door sizes. Further, all of the potentially replaceable parts are the same.

Referring to FIGS. 13A and 13B, the astragal assembly 100 may be configured to prevent light, air, and/or water leakage. Prior art astragal assemblies rely on installers to correctly place and position sealing components (e.g., seals, gaskets, weather-stripping, etc.) necessary to avoid such leakage. Unfortunately, the installers typically do not know where to install these components to achieve optimum performance. In contrast, the glazing tape 202, the weather stripping 204, and the receiver gasket 602 (see FIGS. 16, 17, 19A, and 19B) as well as the slide bolt gasket 502 and the slide bolt pad 504 of the upper and lower slide bolt assemblies 230 and 232 may be installed at the factory and before installation. Thus, installation of these components avoids reliance on installers. Additionally, in the embodiment illustrated, these components are located in positions that are intuitive to installers. As described above, the shoot bolt member 500 clearly indicates the proper location of the slide bolt gasket 502 and the slide bolt pad 504. Similarly, referring to FIG. 16, the sill receiver member 600 indicates the proper location of the receiver gasket 602.

The upper portion of many prior art astragal assemblies typically do not include any sealing components. In the embodiment illustrated, referring to FIG. 13A, the astragal assembly 100 includes the upper slide bolt assembly 230 positioned at the upper end portion 260 of the astragal body 200. The slide bolt gasket 502 and the slide bolt pad 504 of the upper slide bolt assembly 230 fill or seal an upper area between the header member 134 (see FIGS. 1A-3, 18A, and 18B) and the astragal body 200 that is prone to having gaps that allow light, air, and/or water leakage. Likewise, referring to FIG. 13B, the lower slide bolt assembly 232 positioned at the lower end portion 262 of the astragal body 200 includes the slide bolt gasket 502 and the slide bolt pad 504, which fill or seal a lower area between the sill member 132 (see FIGS. 1-3, 16, 19A, and 19B) and the astragal body 200. Referring to FIG. 16, the receiver gasket 602 may also help seal this lower area.

As mentioned in the Background Section, the shoot bolts of many prior art astragal assemblies are difficult to reach. Such shoot bolts are typically only about six to about eight inches long. The top bolt is typically positioned at least six feet above the floor, which, for many users, means that a step stool is required to reach the top bolt. The bottom bolt is typically located about six inches above floor, which requires awkward stooping to operate. Thus, such shoot bolts do not satisfy ADA accessibility guidelines.

Referring to FIG. 1B, the astragal assembly 100 may avoid these reach problems by connecting the upper and lower connecting rods 220 and 222 (see FIGS. 3 and 11) to the lever assembly 210, which may be positioned near the doorknob 182 and/or at least one of the lock mechanisms 184 and 186. Thus, the lever assembly 210 may be located in the same position independently of the height of the active and passive doors 110 and 120. For example, the center of the lever 348 (see FIGS. 6-10) may be positioned about 40 inches to about 47 inches above the floor 137. Further, referring to FIG. 10, the lever 348 may be rotated about 45 degrees with respect to the chassis 340 (or the astragal body 200) from the locked position (see FIG. 9) to the unlocked position (see FIG. 10), which does not significantly change the position of the lever 348 with respect to the floor 137 (see FIGS. 1A and 1B). This rotation operates both the upper and lower slide bolt assemblies 230 and 232 (see FIG. 3). In some embodiments, the lever 348 is rotated less than 45 degrees with respect to the chassis 340 (or the astragal body 200) from the locked position (see FIG. 9) to the unlocked position (see FIG. 10), and vice versa.

When a first amount of force is applied to the lever 348, the lever 348 transitions from the unlocked position (see FIG. 10) to the locked position (see FIG. 9), and vice versa. The lever 348 mechanically increases the first amount of force to a second amount of force that is simultaneously applied to both the upper and lower connecting rods 220 and 222 (see FIGS. 3 and 11). Referring to FIG. 13A, the second amount of force is sufficient to move the upper connecting rod 220 between its distal position (see FIGS. 13A and 18A) and its proximal position (see FIG. 18B) and vice versa. Similarly, referring to FIG. 13B, the second amount of force is also sufficient to move the lower connecting rod 222 between its distal position (see FIGS. 13B and 19A) and its proximal position (see FIG. 19B) and vice versa. The second amount of force simultaneously moves the upper and lower connecting rods 220 and 222 to their distal positions. Further, the second amount of force simultaneously moves the upper and lower connecting rods 220 and 222 to their proximal positions.

As also mentioned in the Background Section, the shoot bolts of many prior art astragal assemblies are difficult to operate. For example, such shoot bolts are typically positioned in a recess that provides only about 0.25 inches of space for the user's fingers. Further, the shoot bolts commonly misalign with the openings in the header or sill, which causes a “fishing” action. Additionally, the ends of the shoot bolts are hidden making alignment with the openings in the header or sill difficult. Installers typically drill the openings into the header and sill, which means the openings may be misplaced and/or misshaped causing the shoot bolts to bind. Some prior art astragal assemblies require that the installers prepare a rough opening but this step is often skipped. Additionally, the location of the openings may change as the doorframe settles over time.

Referring to FIG. 1B, the astragal assembly 100 may avoid these operation problems because the lever 348 (see FIGS. 6-10) may be configured to be easily grasped and operated. Additionally, referring to FIGS. 18A and 19A, the projections 590 of the upper and lower slide bolt assemblies 230 and 232 include the beveled corner portions 594A and 594B (see FIGS. 13A and 13B) that allow up to 0.25 inches of initial misalignment (along forward and rearward directions) with the slot 144 and the through-slot 634, respectively. In the open position (see FIG. 1B), the slot 144 and the through-slot 634 and the ends of the projections 590 are all visible to aid in securing the passive door 120 (see FIGS. 1A-2 and 21). The slot 144, the through-slot 634, and the recess 140 may be formed at the factory using accurate equipment. The slot 144 and the through-slot 634 may extend (side-to-side) along a parallel direction with the header and sill members 134 and 132, respectively, which helps eliminate binding between the projections 590 and the slot 144 and the through-slot 634. The slot 144 and the through-slot 634 may be configured to allow +/− 3/32 inches of misalignment. Thus, the astragal assembly 100 may be well suited for a residential installation settling.

Many prior art astragal assemblies provide little security from unwanted intruders because knowledgeable intruders can operate the shoot bolts from outside the home. This is particularly true for outswing doors. For this reason, many manufacturers incorporate secondary security features that may require manual operation. Unfortunately, it may not be easy to determine if these security features are engaged. Buffeting winds have also been known to open unsecured astragal assemblies.

Referring to FIG. 1B, the astragal assembly 100 may avoid these security problems because the active door 110 must be open for the lever 348 (see FIGS. 6-10) to be operated and the lever 348 must be in the locked position (see FIG. 9) before the active door 110 can be closed. Referring to FIGS. 18A and 19A, placing the lever 348 (see FIGS. 6-10) in the locked position (see FIG. 9) automatically secures the projections 590 of the upper and lower slide bolt assemblies 230 and 232 in the slot 144 and the through-slot 634. Further, the lever 348 (see FIGS. 6-10) exerts constant pressure on the upper and lower slide bolt assemblies 230 and 232 to keep buffeting winds from opening the passive door 120 (see FIGS. 1A-2 and 21). Additionally, referring to FIG. 10, the “over center” design of the lever assembly 210 prevents the lever 348 from inadvertently popping open and prevents intruders from manipulating the upper and lower slide bolt assemblies 230 and 232 (see FIG. 3) from outside home. In other words, the over center mechanism of the lever assembly 210 prevents the lever 348 from being transitioned from the locked position to the unlocked position by applying force to one or both of the upper and lower connecting rods 220 and 222 (see FIGS. 3 and 11). Additionally, referring to FIG. 1B, the active door 110 blocks access to the lever 348 (see FIGS. 6-10) when both the active and passive doors 110 and 120 are in closed positions (see FIG. 1A).

Many prior art double doors may be difficult to install. For example, an installer may have to form holes in the sill and header that are prone to misalignment. Further, removing packaging surrounding the doors typically destabilizes the door unit. As discussed above, referring to FIG. 1B, the astragal assembly 100 does not require that installers form openings in the sill member 132 or the header member 134. Thus, referring to FIGS. 18A and 19A, the astragal assembly 100 avoids common misalignment issues with respect to the slot 144 and the through-slot 634. The astragal assembly 100 also allows the upper and lower slide bolt assemblies 230 and 232 to stabilize the door unit during transportation from the factory to a job site.

It can be difficult to determine whether the shoot bolts of prior art astragal assemblies are positioned inside the openings formed in the sill and header. For example, the shoot bolts often bind before they are completely extended, which compromises both home security and allows leakage (e.g., by light, air, and/or water). Unfortunately, homeowners typically use only one of the shoot bolts. In contrast, referring to FIGS. 18A and 19A, the lever 348 (see FIGS. 6-10) of the astragal assembly 100 makes it quite easy for users to determine that the projections 590 of the upper and lower slide bolt assemblies 230 and 232 in the slot 144 and the through-slot 634. Additionally, the lever 348 (see FIGS. 6-10) provides mechanical advantage that helps move both the upper and lower slide bolt assemblies 230 and 232 distally at the same time.

Sealing systems used on prior art astragal assemblies collide or rub against the sill and/or header. Unfortunately, such interaction wears the sealing systems out and requires greater opening force when opening the passive door. Referring to FIGS. 13A and 13B, in the astragal assembly 100, the upper and lower slide bolt assemblies 230 and 232 each include the slide bolt gasket 502 and the slide bolt pad 504, which move with the upper and lower slide bolt assemblies 230 and 232. Thus, when the lever 348 (see FIGS. 6-10) is in the unlocked position (see FIG. 10), the slide bolt gasket 502 and the slide bolt pad 504 are both spaced apart proximally from the doorframe 130 (see FIGS. 1A and 1B) and do not rub against the doorframe 130 when the passive door 120 (see FIGS. 1A-2 and 21) is opened.

Custom door heights may compromise seals used with many prior art astragal assemblies. For example, the installer must remove a seal from an astragal body thereby breaking adhesive applied between these components by the original manufacturer. The seal is removed to prepare the astragal body to be shortened. Unfortunately, this may damage the seal. Additionally, the astragal body must be shortened to within +/− 1/16 inches of the seal to prevent the seal from leaking (e.g., light, air, and/or water). Further, the seal may be difficult to reattach because of debris and/or the original manufacturer using proprietary and/or special adhesives and procedures to originally attach the seal that cannot be replicated at the job site.

The astragal assembly 100 may avoid these problems with respect to custom height doors because the slide bolt gasket 502 and the slide bolt pad 504 are attached to each of the upper and lower slide bolt assemblies 230 and 232 by the manufacturer. Thus, they do not need to be removed and reinstalled to shorten the astragal body 200. Further, the length of the astragal body 200 is not as critical because the slide bolt gaskets 502 and the slide bolt pads 504 are not attached to the astragal body 200.

Many prior art astragal assemblies include an astragal body constructed from aluminum. Unfortunately, using aluminum has several drawbacks. For example, aluminum's thermal conductivity requires a thermal break. Aluminum astragal bodies are typically hollow, which is difficult to seal against air and/or water leakage. It is also difficult to simulate wood grain, which means veneer may be required. It is difficult to paint and requires a large and costly inventory due to inflexibility of the design. The astragal assembly 100 may avoid these problems by using PVC to construct the astragal body 200. For example, the astragal body 200 may be constructed by extruding foamed PVC. PVC is easier to paint and/or stain than aluminum and woodgrain may be simulated in PVC. Additionally, PVC has a higher thermal resistance. Further, the astragal body 200 may be solid, which is easier to seal. Further, it is easier installers and/or homeowners to install door strikes on the solid astragal body 200.

Many prior art astragal assemblies require the installer to create the openings in the sill and header. These openings (or bolt holes) must be positioned within about 1/16 inches of their desired location to achieve rated product performance. Further, the openings must have a specific hole size and the installer must avoid damaging the finished surfaces of the sill and header. Referring to FIGS. 18A and 19A, the astragal assembly 100 may avoid these problems by forming the slot 144, the through-slot 634, and the recess 140 at the factory.

The active and passive doors are sometimes positioned at different vertical locations. In many prior art astragal assemblies, this creates a gap between the astragal assemblies and the header through which light, air, and/or water may leak. As mentioned above, referring to FIG. 13A, in the astragal assembly 100, the slide bolt gasket 502 and the slide bolt pad 504 are attached to the upper slide bolt assembly 230. Thus, referring to FIG. 1B, even if the active and passive doors 110 and 120 are positioned at different vertical locations, the astragal assembly 100 is sealed with respect to the header member 134. Additionally, referring to FIG. 13A, the shoot bolt member 500 compresses the slide bolt gasket 502 and the slide bolt pad 504 of the upper slide bolt assembly 230 when the shoot bolt member 500 is extended and placed in the distal position. As illustrated in FIG. 2, in multipoint locking systems, the lock mechanisms 186A, 186B, and 184 are located near the top, bottom, and middle, respectively, of the active door 110. Additionally, corresponding strike plates 188A, 188B, and 188C and the associated openings 190A, 190B, and 190C, respectively, are positioned on the astragal body 200. Unfortunately, many prior art astragal assemblies include longer and easier to reach shoot bolts with which these strike plates and openings can interfere. The astragal assembly 100 may avoid this problem by positioning the lever assembly 210 at a location that is different from the locations of the strike plates 188A, 188B, and 188C and the associated openings 190A, 190B, and 190C, respectively. For example, as illustrated in FIG. 2, the strike plate 188B may be positioned near the center of the passive door 120 and the lever assembly 210 may be positioned above the strike plate 188B and below the strike plate 188A.

Multipoint locking systems may also include a locking device and hardware (e.g., doorknobs, escutcheons, and the like) configured to operate the shoot bolts. By way of a non-limiting example, this hardware may include a doorknob that operates the shoot bolts. A rotary motion is typically required to operate such hardware, which is face mounted on the passive door and may not be compatible with the active door. Further, different spindles may be used on this hardware and the doorknob used to open the passive door. The rotary motion is applied to face mounted hardware. In contrast, the lever assembly 210 may be disconnected from any face mounted hardware (e.g., like the doorknob 182). Thus, homeowners can install any locking devices and/or doorknob desired.

Homeowners also typically want to replace the strike plates of many prior art astragal assemblies. Unfortunately, making this replacement will often negatively affect the performance of such astragal assemblies. The astragal assembly 100 allows any strike plates to be installed and used without negatively affecting performance. Further, the upper and lower slide bolt assemblies 230 and 232 are located distally along the astragal body 200 and the rods are positioned away from the centerline along the longitudinal axis “L,” which frees up the central and proximal portions of the astragal body 200 for the strike plates 188A, 188B, and 188C.

The sill member 132 is prone to damage, which typically means the entire sill member 132 must be replaced. Unfortunately, for many prior art astragal assemblies, this means recreating the opening formed in the sill member 132. In contrast, one or both of the adjustable rails “R1” and “R2” may be replaced without disturbing the sill receiver assembly 142 (see FIGS. 1B, 3, 16, 17, 19A, and 19B). Also, the through-slot 634 and the recess 140 need not be recreated, which reduces the likelihood of leaks being created by the replacement(s).

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. An astragal assembly for use with an active panel and a passive panel both mounted in a frame that comprises an opening, the passive panel being hingedly connected to the frame along a first edge, the passive panel having a free second edge opposite the first edge, the astragal assembly comprising:
a lever assembly connected to the free second edge of the passive panel, the lever assembly comprising a lever that is movable between locked and unlocked positions, the active panel blocking access to the lever when both the active and passive panels are in closed positions;
a connecting rod coupled to the lever and being movable thereby, the connecting rod being in a distal position when the lever is in the locked position, the connecting rod being in a proximal position when the lever is in the unlocked position; and
a slide bolt assembly coupled to the connecting rod and movable therewith as a unit, the slide bolt assembly comprising a distally extending projection, the projection being receivable inside the opening when the connecting rod is in the distal position and preventing the passive panel from being rotated to an open position from the closed position, the projection being spaced apart from the opening when the connecting rod is in the proximal position and allowing the passive panel to be rotated to the open position from the closed position.

2. The astragal assembly of claim 1 for use with a floor, wherein the lever is positioned about 40 inches to about 47 inches above the floor.

3. The astragal assembly of claim 1 for use with the frame comprising a header member and a sill member with a sill receiver member, the opening being a first slot, the header member comprising the first slot, the sill receiver member comprising a second slot, wherein the connecting rod is an upper connecting rod, the slide bolt assembly is an upper slide bolt assembly, the projection is an first projection, and the astragal assembly further comprises:
a lower connecting rod coupled to the lever, the lower connecting rod being in a lower position simultaneously with the upper connecting rod being in the distal position when the lever is in the locked position, the lower connecting rod being in an upper position simultaneously with the upper connecting rod being in the proximal position when the lever is in the unlocked position; and
a lower slide bolt assembly coupled to the lower connecting rod and movable therewith as a unit, the lower slide bolt assembly comprising a distally extending second projection, the second projection being receivable inside the second slot when the lower connecting rod is in the lower position and preventing the passive panel from being rotated to an open position from the closed position, the second projection being spaced apart from the second slot when the lower connecting rod is in the upper position and allowing the passive panel to be rotated to the open position from the closed position.

4. The astragal assembly of claim 3, wherein the upper slide bolt assembly comprises at least one upper gasket configured to form a seal with the header member when the upper connecting rod is in the distal position, the at least one upper gasket being spaced apart from the header member when the upper connecting rod is in the proximal position.

5. The astragal assembly of claim 4, wherein the lower slide bolt assembly comprises at least one lower gasket configured to form a seal with the sill receiver member when the lower connecting rod is in the lower position, the at least one lower gasket being spaced apart from the sill receiver member when the lower connecting rod is in the upper position.

6. The astragal assembly of claim 5, further comprising:
an astragal body coupled to the free second edge of the passive panel, the lever assembly being mounted on the astragal body and connected to the free second edge of the passive panel thereby, the astragal body comprising a longitudinal channel in which the upper and lower connecting rods are positioned, the lever being rotatable with respect to the astragal body from the locked position to the unlocked position, the lever providing enough force, when in the locked position, to compress the at least one upper gasket against the header member and to compress the at least one lower gasket against the sill receiver member and to maintain the compression of the at least one upper gasket and the at least one lower gasket so long as the lever remains in the locked position.

7. The astragal assembly of claim 3, further comprising:
an astragal body coupled to the free second edge of the passive panel, the lever assembly being mounted on the astragal body and connected to the free second edge of the passive panel thereby, the astragal body comprising a longitudinal channel in which the upper and lower connecting rods are positioned.

8. The astragal assembly of claim 7, further comprising:
a reinforcement member attached to the astragal body and positioned between the astragal body and the passive panel.

9. The astragal assembly of claim 7, wherein the lever is rotatable with respect to the astragal body between the locked and unlocked positions when a first amount of force is applied to the lever,
the lever mechanically increases the first amount of force to a second amount of force that is simultaneously applied to both the upper and lower connecting rods,
the second amount of force is sufficient to move the upper connecting rod between the distal and proximal positions,
the second amount of force is sufficient to move the lower connecting rod between the lower and upper positions,
the second amount of force moves the upper connecting rod to the distal position simultaneously with the second amount of force moving the lower connecting rod to the lower position, and
the second amount of force moves moves the upper connecting rod to the proximal position simultaneously with the second amount of force moving the lower connecting rod to the upper position.

10. The astragal assembly of claim 9, wherein the lever rotates less than 45 degrees with respect to the astragal body from the locked position to the unlocked position and vice versa.

11. The astragal assembly of claim 1, wherein the lever assembly comprises an over center mechanism that prevents the lever from being transitioned from the locked position to the unlocked position by applying force to the connecting rod.

12. The astragal assembly of claim 1, wherein the slide bolt assembly comprises at least one seal configured to be compressed against the frame when the connecting rod is in the distal position and the passive panel is in the closed position, the at least one seal being spaced apart from the frame when the connecting rod is in the proximal position.

13. The astragal assembly of claim 12, wherein the slide bolt assembly comprises a sidewall and a side facing the passive panel,
the astragal assembly comprises an astragal body coupled to the free second edge of the passive panel,
the at least one seal comprises a gasket mounted on the side facing the passive panel, and
the gasket abuts the sidewall, which prevents the gasket from rubbing against the astragal assembly when the slide bolt assembly moves.

14. The astragal assembly of claim 13, wherein the side of the slide bolt assembly facing the passive panel comprises a recess configured to receive and correctly position the gasket.

15. The astragal assembly of claim 1 being configured to be mounted on the passive panel without the passive panel having been modified before the astragal assembly is mounted thereupon.

16. The astragal assembly of claim 1 for use with the active panel comprising a plurality of locks defining a multipoint lock configuration, each of the plurality of locks operating independently of the lever assembly, the connecting rod, and the slide bolt assembly, wherein each of the lever assembly, the connecting rod, and the slide bolt assembly operates independently of the plurality of locks.

17. The astragal assembly of claim 1, wherein the passive panel is locked and cannot be rotated with respect to the frame when the lever is in the locked position.

18. An assembly for use with a passive panel mounted in a frame that comprises a sill member, the assembly comprising:
a sill receiver member mountable on the sill member, the sill receiver member comprising a through-slot; and
an astragal assembly comprising a slide bolt assembly with a distally extending projection, the slide bolt assembly being movable between distal and proximal positions with respect to the passive panel, the projection being receivable inside the through-slot when the slide bolt assembly is in the distal position to thereby prevent the passive panel from being rotated to an open position from a closed position, the projection being spaced apart from the through-slot when the slide bolt assembly is in the proximal position to thereby allow the passive panel to be rotated to the open position from the closed position.

19. The assembly of claim 18 for use with the sill member comprising first and second adjustable rails, wherein the sill receiver member comprises a lower portion configured to be received in between the first and second adjustable rails, the lower portion comprising the through-slot.

20. The assembly of claim 18 for use with the sill member comprising a recess, wherein the sill receiver member comprises a lower portion configured to be received inside the recess, the lower portion comprising the through-slot.

21. The assembly of claim 18, further comprising:
a gasket mounted on the sill receiver member, the slide bolt assembly comprising a movable seal configured to engage the gasket and form a seal therewith when the slide bolt assembly is in the distal position, the movable seal moving with the slide bolt assembly as the slide bolt assembly moves.

22. The assembly of claim 18, further comprising:
a seal member positionable between the sill receiver member and the sill member.

23. The assembly of claim 18, wherein the astragal assembly further comprises:
a lever assembly attached to the passive panel and coupled to the slide bolt assembly, the lever assembly comprising a lever that is movable between locked and unlocked positions, the lever assembly being operable to move the slide bolt assembly to the distal position when the lever is in the locked position and to move the slide bolt assembly to the proximal position when the lever is in the unlocked position.

24. The assembly of claim 23, wherein the slide bolt assembly is coupled to the lever assembly by a connecting rod,
the astragal assembly further comprises an astragal body comprising a distal portion and a longitudinal channel,
the astragal body is coupled to the passive panel,
the lever assembly is coupled to the astragal body, which attaches the lever assembly to the passive panel,
the connecting rod is positioned inside the longitudinal channel,
the slide bolt assembly is slideably coupled to the distal portion of the astragal body, and
the distal portion of the astragal body is positioned adjacent the through-slot when the passive panel is in the closed position.

25. An assembly comprising:
a frame comprising an opening;
a first moveable member having a first edge opposite a free second edge, the first edge being hingedly connected to the frame and selectively rotatable between open and closed positions; and
an astragal assembly mounted on the free second edge, the astragal assembly comprising a slide bolt assembly with a distally extending projection, the slide bolt assembly being movable between distal and proximal positions with respect to the first moveable member, the projection being receivable inside the opening when the slide bolt assembly is in the distal position to thereby prevent the first moveable member from being rotated to an open position from a closed position, the projection being spaced apart from the opening when the slide bolt assembly is in the proximal position to thereby allow the first moveable member to be rotated to the open position from the closed position.

26. The assembly of claim 25, wherein the first moveable member is a door, a panel, a window, or a skylight.

27. The assembly of claim 25, further comprising:
a second moveable member hingedly connected to the frame and selectively rotatable between open and closed positions, the astragal assembly being positioned between the first and second moveable members when both the first and second moveable members are in closed positions.

28. The assembly of claim 27, wherein the first and second moveable members are doors, panels, windows, or skylights.
